(19) United States
(12) Patent Application Publication
(10) Pub. No.: US 2011/0259571 A1
(43) Pub. Date: Oct. 27, 2011

(54) HYDROPHILIC COMPOSITION AND HYDROPHILIC MEMBER HAVING ANTIFUNGAL PROPERTY

(75) Inventors: Sumiaki Yamasaki, Minami-Ashigara-shi (JP); Yuichiro Murayama, Odawara-shi (JP)

(73) Assignee: FUJIFILM CORPORATION, Tokyo (JP)

(21) Appl. No.: 13/124,766

(22) PCT Filed: Oct. 15, 2009
(86) PCT No.: PCT/JP2009/067852

§ 371 Date: Jul. 5, 2011

(30) Foreign Application Priority Data
Oct. 17, 2008 (JP) 2008-268777

(51) Int. Cl. F28F 7/00; B32B 15/04; B32B 27/36; C09D 5/14; B32B 27/00

(52) U.S. Cl. 165/185; 523/122; 428/412; 428/480; 428/457

(57) ABSTRACT

The invention can provide a hydrophilic composition and a hydrophilic member having high hydrophilic property and excellent durability and high antifungal effect.

The hydrophilic composition includes a hydrophilic polymer (I) that includes a specific structure and an additive having antibacterial or antifungal property in an amount exceeding 10 mass % with respect to the total solids content of the hydrophilic composition.

### TECHNICAL FIELD

The present invention relates to a hydrophilic composition and a hydrophilic member which each have antibacterial or antifungal property and, more specifically, to a hydrophilic composition and a hydrophilic member which each not only display high hydrophilicity for a long time, which each also can retain their antibacterial and antifungal property.

### BACKGROUND ART

It has been known to impart antifogging properties and self-cleaning properties to the surface of a substrate of every kind. For example, there are known building materials, exteriors of buildings such as exterior walls and roofs; interiors of buildings, window frames, window panes, and structural members; exteriors and coatings of vehicles such as automobiles, rail cars, aircraft, boats and ships, bicycles, and motorbikes; exteriors, dust-resistant covers and coatings of mechanical devices and articles; exteriors and coatings of traffic signs, various display devices, advertising towers, road sound abatement shields, railroad soundproof walls, bridges, and guardrails; interiors and coatings of tunnels; insulators, solar cell covers, heat collecting covers of solar water heaters, vinyl houses, panel light covers of cars, handcuffs, home accommodations, toilets, bathtubs, washstands, lighting fixtures, illumination covers, kitchen utensils, dishes, dish washers, dish driers, sinks, kitchen ranges, kitchen hoods, ventilating fans, and an aluminum fin stock for an air-conditioner. Of these, bathtubs, washstands, kitchen utensils, fin stocks for air-conditioners, and the like involve the problems that various fungi grow due to water adhering to the surface of the members to give off an unpleasant smell.

Various techniques have been known to suppress growth of fungi and to hydrophilize. As such examples, there can be illustrated use of anti-bacterial and antifungal agents having hydrophilizing properties and being obtained from natural products (see, for example, patent document 1), a technique of imparting antifungal property and hydrophilicity to a substrate by applying a multi-layer film having a PVA based hydrophilic polymer layer and a layer of an aqueous emulsion adhesive containing a hydrophilic organic antifungal agent (see, for example, patent document 2), a technique of imparting antifungal property and hydrophilicity to the surface of a metal by applying an antibacterial and antifungal layer containing a polymer to which a phosphonium base is bound to the main chain or side chain thereof and containing a hydrophilic substance (see, for example, patent document 3), an aluminum fin stock to which antibacterial and antifungal property and hydrophilicity are imparted (see, for example, patent document 4), and a plastic bathtub carrying thereon a hydrophilic inorganic oxide and an antibacterial agent (see, for example, patent document 5).

The above-described examples are conventional art of adding antifungal agents. However, though they exhibit some antifungal effects, they fail to provide sufficient hydrophilicity, and hence there result insufficient self-cleaning properties and, after long-term use, the hydrophilic layer and the antifungal agents are carried away due to water condensed on the surface of the hydrophilic layer, thus durability of not only hydrophilicity but antifungal function having been insufficient.

The conventional art as described in the documents uses, as a hydrophilic composition, a thermoplastic polymer having a hydrophilic group. For example, document 2 describes polyvinyl alcohol having a hydroxyl group as the hydrophilic group, document 3 describes a polyester resin having a phosphonium group, and document 4 describes an acrylic resin having a sulfonic acid group. However, since these resins do not have any cross-linked structure in the coated film, they show such poor water resistance that not only the hydrophilic layer but also the antifungal agents are dissolved away, leading to the aforesaid defects. A hydrophilic coated film having a cross-linked structure for imparting water resistance and also having long-lasting antifungal function is desired.

In addition, techniques with respect to a hydrophilic composition which can form a film with antifouling and antifogging properties and wear resistance have also been disclosed (see, for example, patent document 6). However, since this composition does not contain antibacterial agents or antifungal agents, it can suffer growth of bacteria and fungi when stored for a long period under the environment of high temperature and high humidity.

### PRECEDING TECHNICAL DOCUMENTS

### Patent Document

Patent document 1: JP-A-2007-230920
Patent document 2: JP-A-2006-281580
Patent document 3: JP-A-11-277672
Patent document 4: JP-A-2000-171191
Patent document 5: JP-A-2000-273401
Patent document 6: JP-A-2007-269932

### SUMMARY OF THE INVENTION

### Problems that the Invention is to Solve

The invention aims to provide a hydrophilic composition which has high hydrophilicity and persistent hydrophilicity and forms a hydrophilic layer having excellent antibacterial and antifungal effect, and further to provide a hydrophilic member.

### Means for Solving the Problems

As a result of intensive studies, the present inventors have found that the aim can be attained with a hydrophilic composition and a hydrophilic member which each include a hydrophilic polymer having a specific structure shown below and an additive having antibacterial or antifungal property in an amount exceeding 10 mass % with respect to the total solids content in the hydrophilic composition.
[1] A hydrophilic composition which comprises a hydrophilic polymer (I) containing a structure represented by the following general formula (I-1) and a structure represented by the following general formula (I-2), and an additive having antibacterial or antifungal property in an amount exceeding 10 mass % with respect to the total solids content of the hydrophilic composition:

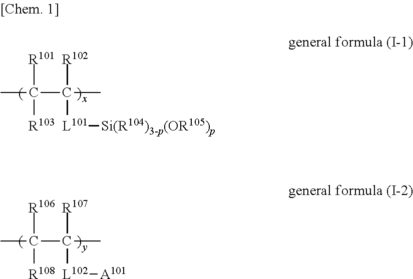

wherein, in the general formulae (I-1) and (I-2), R¹⁰¹ to R¹⁰⁸ each independently represents a hydrogen atom or a hydrocarbon group, p represents an integer of from 1 to 3, L¹⁰¹ and L¹⁰² each independently represents a single bond or a polyvalent organic linking group, x and y each represents a composition ratio, with x being 0<x<100 and y being 0<y<100, A¹⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), in which Rₐ, R_{b}, and R_{c} each independently represents a hydrogen atom or a straight, branched or cyclic alkyl group, R_{d} represents a straight, branched or cyclic alkyl group, Rₑ and R_{f} each independently represents a hydrogen atom, a straight, branched or cyclic alkyl group, an alkali metal, an alkaline earth metal or an onium, and R_{g} represents a halogen ion, an inorganic anion or an organic anion.
[2] The hydrophilic composition as described in [1], which further comprises a hydrophilic polymer (II) which includes a structure represented by the following general formula (II-1) and a structure represented by the following general formula (II-2):

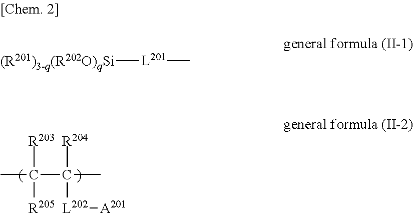

wherein, in the general formulae (II-1) and (II-2), R²⁰¹ to R²⁰⁵ each independently represents a hydrogen atom or a hydrocarbon group, q represents an integer of 1 to 3, L²⁰¹ to L²⁰² each independently represents a single bond or a polyvalent organic linking group, A²⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), in which Rₐ, R_{b} and R_{c} each independently represents a hydrogen atom or a straight, branched or cyclic alkyl group, R_{d} represents a straight, branched or cyclic alkyl group, Rₑ and R_{f} each independently represents a hydrogen atom, a straight, branched or cyclic alkyl group, an alkali metal, an alkaline earth metal or an onium, and R_{g} represents a halogen ion, an inorganic anion or an organic anion.
[3] The hydrophilic composition as described in [1] or [2], wherein the additive having antibacterial or antifungal property is contained in an amount of 15 to 70 mass % with respect to the total solids content of the hydrophilic composition.
[4] The hydrophilic composition as described in [2] or [3], wherein a mass ratio of the hydrophilic polymer (I) to the hydrophilic polymer (II), being contained in the hydrophilic composition, (hydrophilic polymer (I)/hydrophilic polymer (II)) is in a range of from 50/50 to 95/5.
[5] The hydrophilic composition as described in any one of [1] to [4], wherein the additive having antibacterial or antifungal property contains at least one member selected from a water-soluble or water-dispersible organic compound and a silver based inorganic compound.
[6] The hydrophilic composition as described in any one of [1] to [5], wherein the additive having antibacterial or antifungal property contains at least one member selected from an imidazole based compound, an arsine based compound, a pyridine based compound and a silver based compound.
[7] The hydrophilic composition as described in any one of claims 1 to 6, wherein the additive having antibacterial or antifungal property contains at least one member selected from 2-(4-thiazolyl)benzimidazole, methyl 2-benzimidazole carbamate, 10,10′-oxybisphenoxyarsine, bis(2-pyridylthio-1-oxide)zinc, silicate based silver zeolite and silver behenate.
[8] A hydrophilic member which contains a hydrophilic layer formed with the hydrophilic composition as described in any one of [1] to [7] on a substrate selected from acrylic resin, polycarbonate based resin, polyester based resin, stainless steel and aluminum.
[9] A fin stock which contains a fin body and a hydrophilic layer provided on at least part of the surface of the fin body, wherein the hydrophilic layer is formed by coating with the hydrophilic composition as described in any one of [1] to [7].
[10] The fin stock as described in [9], wherein the fin body is made from aluminum.
[11] A heat exchanger which utilizes the fin stock as described in [10].
[12] An air conditioner which utilizes the heat exchanger as described in [11].

### Advantage of the Invention

The hydrophilic composition according to the invention has high and persistent hydrophilicity, and can form a hydrophilic layer having excellent antibacterial and antifungal effect. In addition, the composition can provide a hydrophilic member which is very high in contact angle to water and shows excellent hydrophilic properties, what's more which has high and persistent hydrophilicity and excellent antibacterial and antifungal effect.

### Mode for Carrying Out the Invention

The invention is described below in detail.

The present hydrophilic composition contains a hydrophilic polymer (I) in which a structure represented by the following general formula (I-1) and a structure represented by the following general formula (I-2) are included, and an additive having an antibacterial or antifungal property in an amount exceeding 10 mass % with respect to the total solids content in the hydrophilic composition.

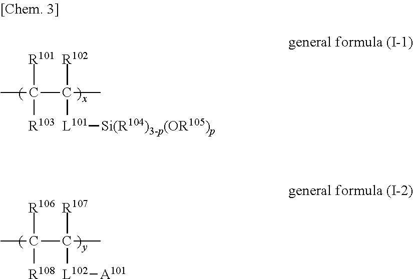

In the general formulae (I-1) and (I-2), R¹⁰¹ to R¹⁰⁸ each independently represents a hydrogen atom or a hydrocarbon group, p represents an integer of from 1 to 3, and L¹⁰¹ and L¹⁰² each independently represents a single bond or a polyvalent organic linking group, x and y each represents a composition ratio, with x being 0<x<100 and y being 0<y<100, A¹⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), in which Rₐ, R_{b}, and R_{c} each independently represents a hydrogen atom or a straight, branched or cyclic alkyl group, R_{d} represents a straight, branched or cyclic alkyl group, Rₑ and R_{f} each independently represents a hydrogen atom, a straight, branched or cyclic alkyl group, an alkali metal, an alkaline earth metal or an onium, and R_{g} represents a halogen ion, an inorganic anion or an organic anion.

It is thought that utilization of the hydrophilic polymer (I) having a hydrophilic structure, such as that of polyacrylamide, and alkoxysilyl group for forming a cross-linked structure as a composition for imparting hydrophilic properties has allowed no elution of hydrophilic layer with water adhering to the hydrophilic surface and attainment of high water resistance of long duration in addition to retention of high hydrophilicity.

Moreover, because an antibacterial agent and an antifungal agent, such as zinc pyrithione and silver zeolite, are trapped in three-dimensional reticulation structure by the cross-linked structure, no elution thereof occurs and their antibacterial and antifungal effect can be retained for a long time.

### [(A) Hydrophilic Polymer (I) Containing the Structure Represented by the General Formula (I-1) and the Structure Represented by the General Formula (I-2)]

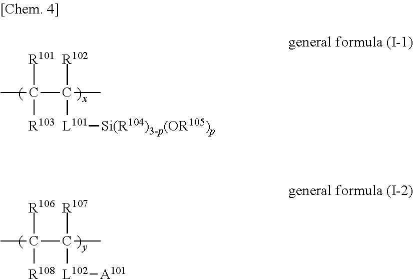

In the general formulae (I-1) and (I-2), R¹⁰¹ to R¹⁰⁸ each independently represents a hydrogen atom or a hydrocarbon group, p represents an integer of from 1 to 3, L¹⁰¹ and L¹⁰² each represents a single bond or a polyvalent organic linking group, x and y each represents a composition ratio, with x being 0<x<100 and y being 0<y<100, A¹⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), in which Rₐ, R_{b}, and R_{c} each independently represents a hydrogen atom or a straight, branched or cyclic alkyl group, R_{d} represents a straight, branched or cyclic alkyl group, Rₑ and R_{f} each independently represents a hydrogen atom, a straight, branched or cyclic alkyl group, an alkali metal, an alkaline earth metal or an onium, and R_{g} represents a halogen ion, an inorganic anion or an organic anion.

In the general formulae (I-1) and (I-2), R¹⁰¹ to R¹⁰⁸ each independently represents a hydrogen atom or a hydrocarbon group. As the hydrocarbon group, there are illustrated an alkyl group, an aryl group, etc., with a straight, branched or cyclic alkyl group containing from 1 to 8 carbon atoms being preferred. Specifically, there are illustrated a methyl group, an ethyl group, a propyl group, a butyl group, a pentyl group, a hexyl group, a heptyl group, an octyl group, an isopropyl group, an isobutyl group, a s-butyl group, a t-butyl group, an isopentyl group, a neopentyl group, a 1-methylbutyl group, an isohexyl group, a 2-ethylhexyl group, a 2-methylhexyl group, and a cyclopentyl group. In view of effectiveness and availability, R¹⁰¹ to R¹⁰⁸ each preferably is a hydrogen atom, a methyl group or ethyl group.

These hydrocarbon groups may further have a substituent. When the alkyl group has a substituent, the substituted alkyl group is constituted by the substitute and an alkylene group connected to each other and, as the substituent, a monovalent non-metallic atom group except for a hydrogen atom is used. Preferred examples thereof include a halogen atom (—F, —Br, —Cl or —I), a hydroxyl group, an alkoxy group, an aryloxy group, a mercapto group, an alkylthio group, an arylthio group, an alkyldithio group, an aryldithio group, an amino group, an N-alkylamino group, an N,N-diarylamino group, an N-alkyl-N-arylamino group, an acyloxy group, a carbamoyloxy group, an N-alkylcarbamoyloxy group, an N-arylcarbamoyloxy group, an N,N-dialkylcarbamoyloxy group, an N,N-diarylcarbamoyloxy group, an N-alkyl-N-rylcarbamoyloxy group, an alkylsulfoxy group, an arylsulfoxy group, an acylthio group, an acylamino group, an N-alkylacylamino group, an N-arylacylamino group, a ureido group, an N′-alkylureido group, an N′,N′-dialkylureido group, an N′-arylureido group, an N′,N′-diarylureido group, an N′-alkyl-N′-arylureido group, an N-alkylureido group, an N-arylureido group, an N′-alkyl-N-alkylureido group, an N′-alkyl-N-arylureido group, an N′,N′-dialkyl-N-alkylureido group, an N′,N′-dialkyl-N-arylureido group, an N′-aryl-N-alkylureido group, an N′-aryl-N-arylureido group, an N′,N′-diaryl-N-alkylureido group, an N′,N′-diaryl-N-arylureido group, an N′-alkyl-N′-aryl-N-alkylureido group, an N′-alkyl-N′-aryl-N-arylureido group, an alkoxycarbonylamino group, an aryloxycarbonylamino group, an N-alkyl-N-alkoxycarbonylamino group, an N-alkyl-N-aryloxycarbonylamino group, an N-aryl-N-alkoxycarbonylamino group, an N-aryl-N-aryloxycarbonylamino group, a formyl group, an acyl group, a carboxyl group, an alkoxycarbonyl group,

an aryloxycarbonyl group, a carbamoyl group, an N-alkylcarbamoyl group, an N,N-dialkylcarbamoyl group, an N-arylcarbamoyl group, an N,N-diarylcarbamoyl group, an N-alkyl-N-arylcarbamoyl group, an alkylsulfinyl group, an arylsulfinyl group, an alkylsulfonyl group, anarylsulfonyl group, a sulfo group (—SO₃H) and a conjugate base group thereof (hereinafter referred to as a sulfonato group), an alkoxysulfonyl group, an aryloxysulfonyl group, a sulfinamoyl group, an N-alkylsulfinamoyl group, an N,N-dialkylsulfinamoyl group, an N-arylsulfinamoyl group, an N,N-diarylsulfinamoyl group, an N-alkyl-N-arylsulfinamoyl group, a sulfamoyl group, an N-alkylsulfamoyl group, an N,N-dialkylsulfamoyl group, an N-arylsulfamoyl group, an N,N-diarylsulfamoyl group, an N-alkyl-N-arylsulfamoyl group, a phosphono group (—PO₃H₂) and a conjugate base group thereof (hereinafter referred to as a phosphonato group), a dialkylphosphono group (—PO₃(alkyl)₂), a diarylphosphono group (—PO₃(aryl)₂), an alkylarylphosphono group (—PO₃(alkyl)(aryl)), a monoalkylphosphono group (—PO₃H(alkyl)) and a conjugate base group thereof (hereinafter referred to as an alkylphosphonato group), a monoarylphosphono group (—PO₃H(aryl)) and a conjugate base group thereof (hereinafter referred to as an arylphosphonato group), a phosphonoxy group (—OPO₃H₂) and a conjugate base group thereof (hereinafter referred to as a phosphonatoxy group), a dialkylphosphonoxy group (—OPO₃(alkyl)₂), a diarylphosphonoxy group (—OPO₃(aryl)₂), an alkylarylphosphonoxy group (—OPO(alkyl)(aryl)), a monoalkylphosphonoxy group (—OPO₃H(alkyl)) and a conjugate base group thereof (hereinafter referred to as an alkylphosphonatoxy group), a monoarylphosphonoxy group (—OPO₃H(aryl)) and a conjugate base group thereof (hereinafter referred to as an arylphosphonatoxy group), a morpholino group, a cyano group, a nitro group, an aryl group, an alkenyl group, and an alkynyl group.

As specific examples of the alkyl group in these substituents, there are similarly illustrated those alkyl groups which have been illustrated hereinbefore with respect to R¹ to R⁸ and, as specific examples of the aryl group, there can be illustrated a phenyl group, a biphenyl group, a naphthyl group, a tolyl group, a xylyl group, a mesityl group, a cumenyl group, a chlorophenyl group, a bromophenyl group, a chloromethylphenyl group, a hydroxyphenyl group, a methoxyphenyl group, an ethoxyphenyl group, a phenoxyphenyl group, an acetoxyphenyl group, a benzoyloxyphenyl group, a methylthiophenyl group, a phenylthiophenyl group, a methylaminophenyl group, a dimethylaminophenyl group, an acetylaminophenyl group, a carboxyphenyl group, a methoxycarbonylphenyl group, an ethoxyphenylcarbonyl group, a phenoxycarbonylphenyl group, an N-phenylcarbamoylphenyl group, a phenyl group, a cyanophenyl group, a sulfophenyl group, a sulfonatophenyl group, a phosphonophenyl group, and a phosphonatophenyl group. Also, as examples of the alkenyl group, there are illustrated a vinyl group, a 1-propenyl group, a 1-butenyl group, a cinnamyl group, and a 2-chloro-1-ethenyl group and, as examples of the alkynyl group, there are illustrated an ethynyl group, a 1-propynyl group, a 1-butynyl group, and a trimethylsilylethynyl group. As G¹ in the acyl group (G¹CO—), there can be illustrated a hydrogen, and the above-described alkyl groups and aryl groups.

Of these substituents, a halogen atom (—F, —Br, —Cl or —I), an alkoxy group, an aryloxy group, an alkylthio group, an arylthio group, an N-alkylamino group, an N,N-dialkylamino group, an acyloxy group, an N-alkylcarbamoyloxy group, an N-arylcarbamoyloxy group, an acylamino group, a formyl group, an acyl group, a carboxyl group, an alkoxycarbonyl group, an aryloxycarbonyl group, a carbamoyl group, an N-alkylcarbamoyl group, an N,N-dialkylcarbamoyl group, an N-arylcarbamoyl group, an N-alkyl-N-arylcarbamoyl group, a sulfo group, a sulfonato group, a sulfamoyl group, an N-alkylsulfamoyl group, an N,N-dialkylsulfamoyl group, an N-arylsulfamoyl group, an N-alkyl-N-arylsulfamoyl group, a phosphono group, a phosphonato group, a dialkylphosphono group, a diarylphosphono group, a monoalkylphosphono group, an alkylphosphonato group, a monoarylphosphono group, an arylphosphonato group, a phosphonoxy group, a phosphonatoxy group, an aryl group, and an alkenyl group are more preferred.

On the other hand, as the alkylene group in the substituted alkyl group, there can be illustrated preferably those which are formed by removing any one of the hydrogen atoms of the aforesaid alkyl group containing from 1 to 20 carbon atoms to leave a divalent organic residue and, more preferably, there can be illustrated straight alkylene groups containing from 1 to 12 carbon atoms, still more preferably, from 1 to 8 carbon atoms, branched alkylene groups containing from 3 to 12 carbon atoms, still more preferably, from 3 to 8 carbon atoms, and cyclic alkylene groups containing from 5 to 10 carbon atoms, still more preferably, from 5 to 8 carbon atoms,. As preferred specific examples of the substituted alkyl group obtained by combining the substituent and the alkylene group, there can be illustrated a chloromethyl group, a bromomethyl group, a 2-chloroethyl group, a trifluoromethyl group, a hydroxymethyl group, a methoxymethyl group, a methoxyethoxyethyl group, an allyloxymethyl group, a phenoxymethyl group, a methylthiomethyl group, a tolylthiomethyl group, an ethylaminoethyl group, a diethylaminopropyl group, a morpholinopropyl group, an acetyloxymethyl group, a benzoyloxymethyl group, an N-cyclohexylcarbamoyloxyethyl group, an N-phenylcarbamoyloxyethyl group, an acetylaminoethyl group, an N-methylbenzoylaminopropyl group, a 2-hydroxyethyl group, a 2-hydroxypropyl group, a carboxypropyl group, a methoxycarbonylethyl group, an allyloxycarbonylbutyl group,

a chlorophenoxycarbonylmethyl group, a carbamoylmethyl group, an N-methylcarbamoylethyl group, an N,N-dipropylcarbamoylmethyl group, an N-(methoxyphenyl)carbamoylethyl group, an N-methyl-N-(sulfophenyl)carbamoylmethyl group, a sulfobutyl group, a sulfonatobutyl group, a sulfamoylbutyl group, an N-ethylsulfamoylmethyl group, an N,N-dipropylsulfamoylpropyl group, an N-tolylsulfamoylpropyl group, an N-methyl-N-(phosphonophenyl)sulfamoyloctyl group, a phosphonobutyl group, a phosphonatohexyl group, a diethylphosphonobutyl group, a diphenylphosphonopropyl group, a methylphosphonobutyl group, a methylphosphonatobutyl group, a tolylphosphonohexyl group, a tolylphosphonatohexyl group, a phosphonoxypropyl group, a phosphonatoxybutyl group, a benzyl group, a phenethyl group, an α-methylbenzyl group, a 1-methyl-1-phenylethyl group, a p-methylbenzyl group, a cinnamyl group, an allyl group, a 1-propenylmethyl group, a 2-butenyl group, a 2-methylallyl group, a 2-methylpropenylmethyl group, a 2-propynyl group, a 2-butynyl group, and a 3-butynyl group. In view of hydrophilicity, a hydroxymethyl group is particularly preferred.

In view of hydrophilicity, a hydroxymethyl group is preferred among the above-described groups.

L¹⁰¹ and L¹⁰² represent a single bond or an organic linking group. Here, the term “single bond” means that the main chain of the polymer and X are directly connected to each other without any linking chain.

In the case where L¹⁰¹ and L¹⁰² represent an organic linking group, L¹⁰¹ and L¹⁰² represent a polyvalent linking group comprising non-metallic atoms of from 0 to 60 carbon atoms, from 0 to 10 nitrogen atoms, from 0 to 50 oxygen atoms, from 0 to 100 hydrogen atoms, and from 0 to 20 sulfur atoms. Specifically, a preferred one is selected from among —N<, an aliphatic group, an aromatic group, a heterocyclic group, and a combination thereof, and L¹⁰² is preferably —O—, —S—, —CO—, —NH— or a divalent linking group comprising a combination containing —O—, —S—, —CO— or —NH—.

As more specific linking groups, there can be illustrated those which are constituted by the following structural units or a combination thereof.

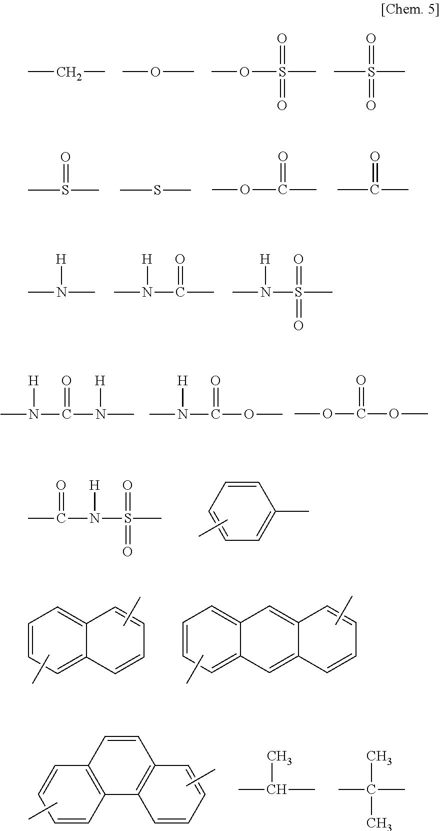

In the general formula (I-1), it is preferable that L¹⁰¹ is a single bond or a linking group containing one or more structures selected from the group consisting of —CONH—, —NHCONH—, —OCONH—, —SO₂NH—, and —SO₃—.

In the general formula (I-2), A¹⁰¹ represents —OH, —ORₐ, —CORₐ, —CO₂Rₑ, —CON(Rₐ)(R_{b}), —N(Rₐ)(R_{b}), —NHCOR_{d}—, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ). Here, Rₐ, R_{b}, and R_{c} each independently represents a hydrogen atom or a straight, branched or cyclic alkyl group (containing preferably from 1 to 8 carbon atoms), R_{d} represents a straight, branched or cyclic alkyl group (containing preferably from 1 to 8 carbon atoms), Rₑ and R_{f} each independently represents a hydrogen atom, a straight, branched or cyclic alkyl group (containing preferably from 1 to 8 carbon atoms), an alkali metal, an alkaline earth metal or an onium, and R_{g} represents a halogen ion, an inorganic anion or an organic anion. Also, with —CON(Rₐ)(R_{b}), —N(Rₐ)(R_{b}), —OCON(Rₐ)(R_{b}), —NHCON(Rₐ)(R_{b}), —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), Rₐ to R_{g} may be connected to each other to form a ring, and the formed ring may be a heterocyclic ring which contains a hetero atom such as oxygen atom, sulfur atom, nitrogen atom or the like. Rₐ to R_{g} may further have a substituent and, as the introducible substituent, there can similarly be illustrated those which have been illustrated hereinbefore as substituents introducible in the case where R¹ to R⁸ are alkyl groups.

As the straight, branched or cyclic alkyl group for Rₐ to R_{f}, there are preferably illustrated, specifically, a methyl group, an ethyl group, a propyl group, a butyl group, a pentyl group, a hexyl group, a heptyl group, an octyl group, an isopropyl group, an isobutyl group, a s-butyl group, a t-butyl group, an isopentyl group, a neopentyl group, a 1-methylbutyl group, an isohexyl group, a 2-ethylhexyl group, a 2-methylhexyl group, and a cyclopentyl group.

Also, as the alkali metal for Rₐ to R_{g}, there are illustrated an alkali metal such as lithium, sodium or potassium; an alkaline earth metal such as barium; and onium such as ammonium, iodonium or sulfonium.

As the halogen ion, there can be illustrated a fluorine ion, chlorine ion, and bromine ion. As the inorganic anion, there are preferably illustrated a nitrate anion, a sulfate anion, a tetrafluoroborate anion, and a hexafluorophosphate anion and, as the organic anion, there are preferably illustrated a methanesulfonate anion, a trifluoromethanesulfonate anion, a nonafluorobutanesulfonate anion, and a p-toluenesulfonate anion.

As A¹⁰¹, specifically, —NHCOCH₃, —CONH₂, —CON(CH₃)₂, —COOH, —SO₃⁻NMe₄⁺, —SO₃⁻K⁺, —(CH₂CH₂O)ₙH, a morpholyl group, etc. are preferred. —NHCOCH₃, —CONH₂, —CON(CH₃)₂, —SO₃⁻K⁺, and —(CH₂CH₂O)ₙH are more preferred. Additionally, in the above description, n represents preferably an integer of from 1 to 100.

p represents an integer of from 1 to 3, preferably 2 or 3, more preferably 3.

In the hydrophilic polymer containing the structure represented by the general formula (I-1) and the general formula (I-2), x and y each represents a composition ratio of the structure unit represented by the general formula (I-1) and the structure unit represented by the general formula (I-2) in the (A) specific hydrophilic polymer, with x being 0<x<100 and y being 0<y<100. x is preferably in the range of 1<x<90, more preferably in the range of 1<x<50. y is preferably in the range of 10<x<99, more preferably in the range of 50<x<99.

The copolymerization proportion of the structure represented by the general formula (I-1) and the general formula (I-2) in the hydrophilic polymer (I) can be arbitrarily determined so that the amount of the unit of the general formula (I-2) having the hydrophilic group falls within the above-described range. The molar ratio (y) of the structural unit of the general formula (I-2) to the molar ratio (x) of the structural unit of the general formula (I-1) having the hydrolysable silyl group amount, y/x, is preferably in the range of from 30/70 to 99/1, more preferably from 40/60 to 98/2, most preferably from 50/50 to 97/3. When y/x is equal to or more than 30/70, there results sufficient hydrophilicity whereas, when y/x is equal to or less than 99/1, the amount of the hydrolyzable silyl group becomes enough to provide sufficient hardness and sufficient film strength.

The mass-average molecular weight of the polymer containing the structure represented by the general formula (I-1) and the general formula (I-2) is preferably from 1,000 to 1,000,000, more preferably from 1,000 to 500,000, most preferably from 1,000 to 200,000.

Specific examples of the hydrophilic polymer containing the structure represented by the general formula (I-1) and the general formula (I-2) will be described below together with the mass-average molecular weights (M.W.) thereof. However, the invention is not limited at all by them. Additionally, the specific polymers shown below mean random copolymers or block copolymers containing respective structural units in the described molar ratios.

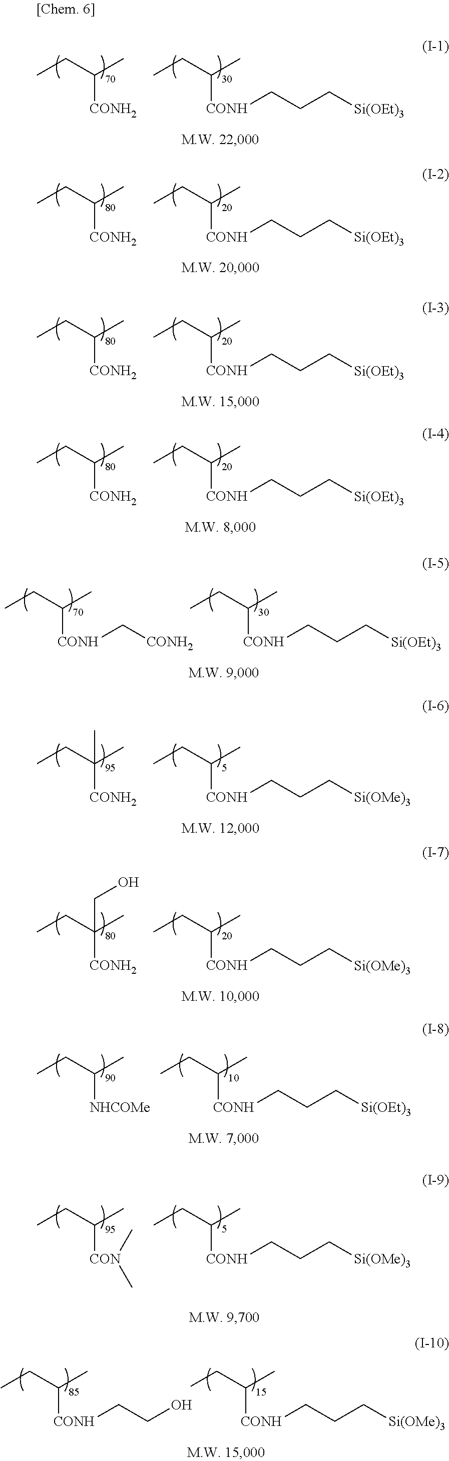

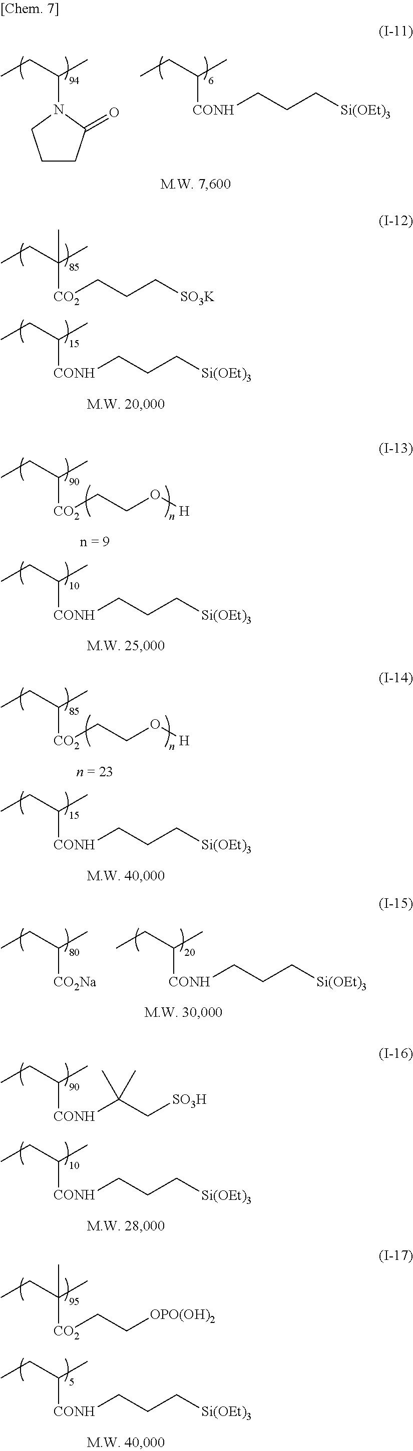

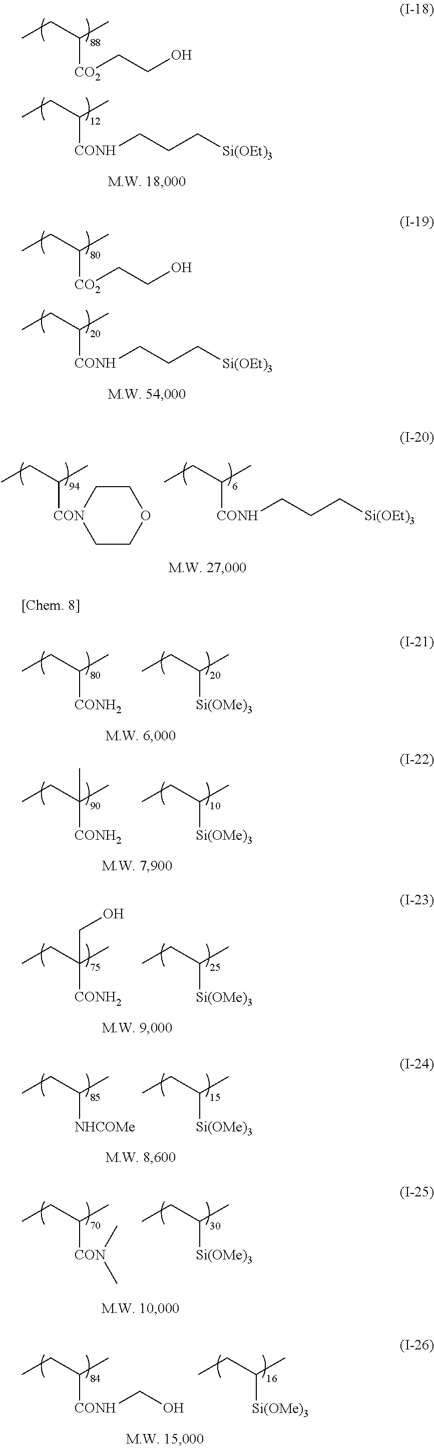

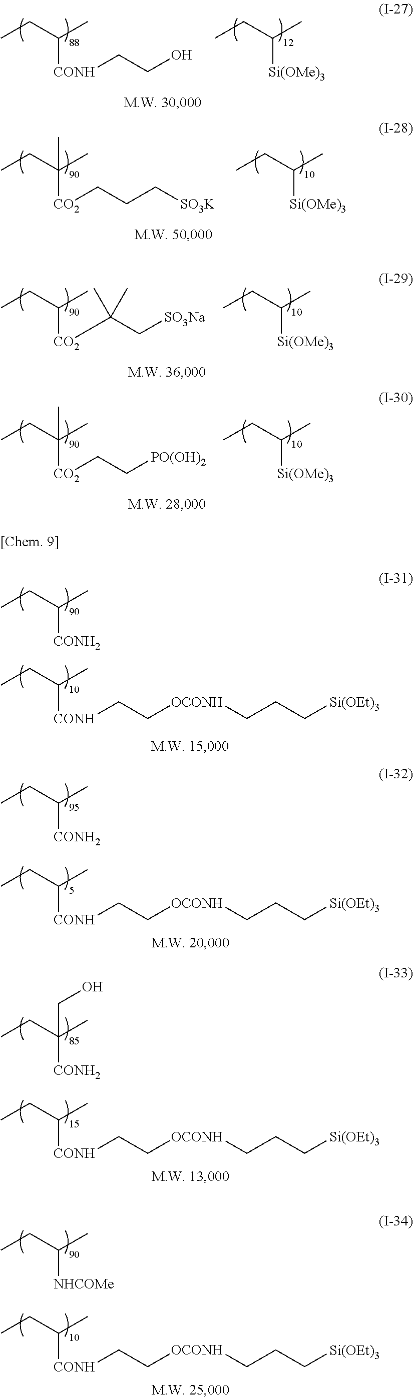

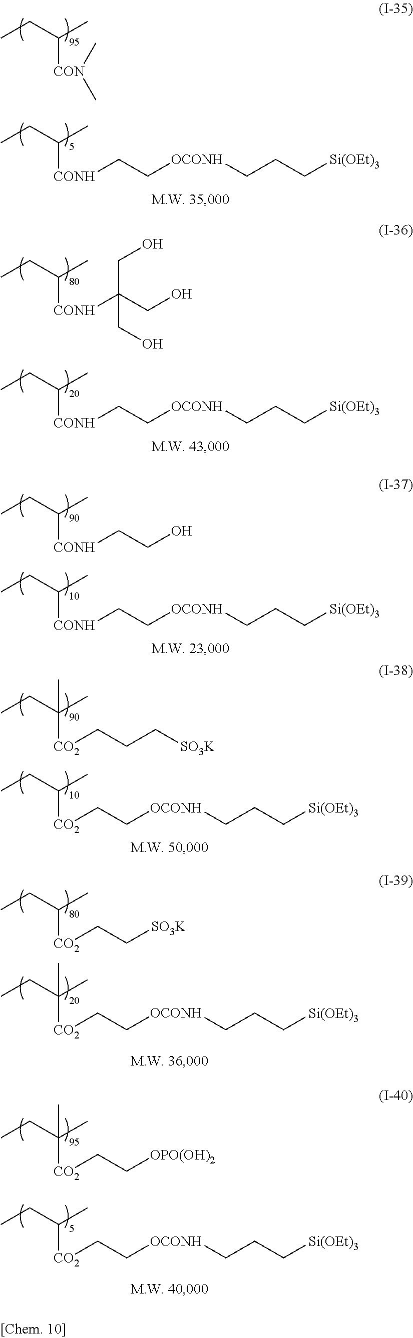

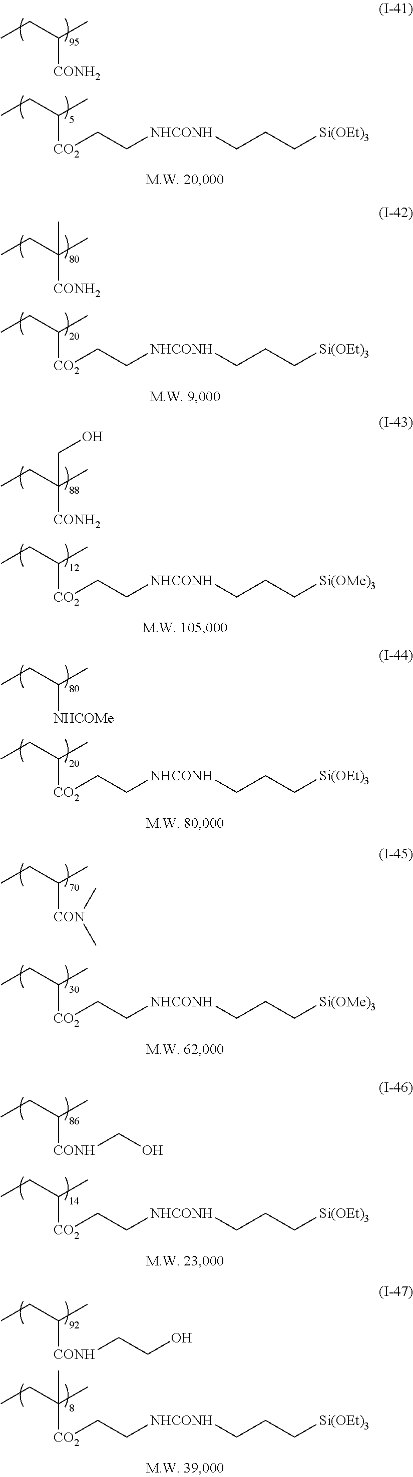

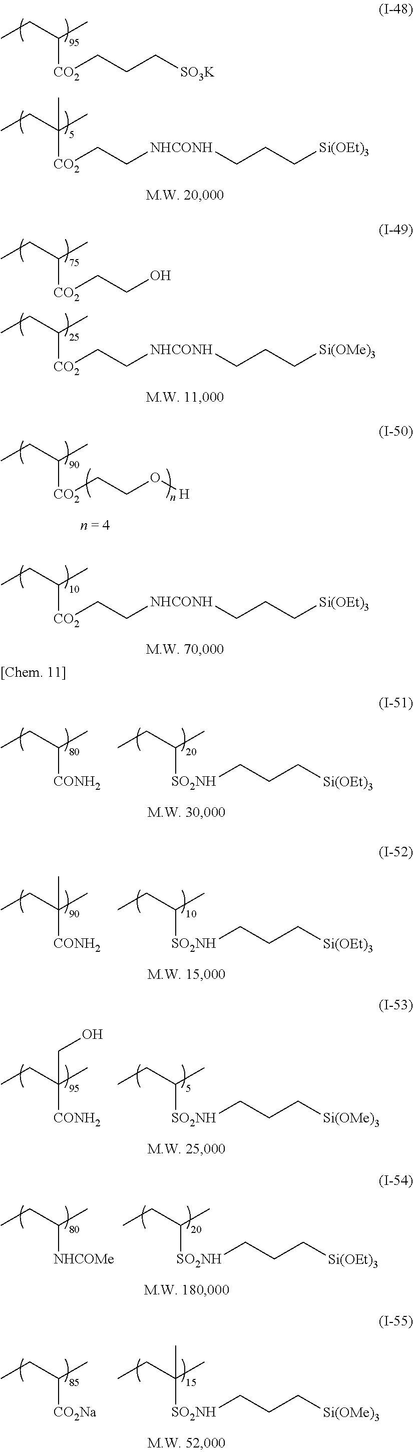

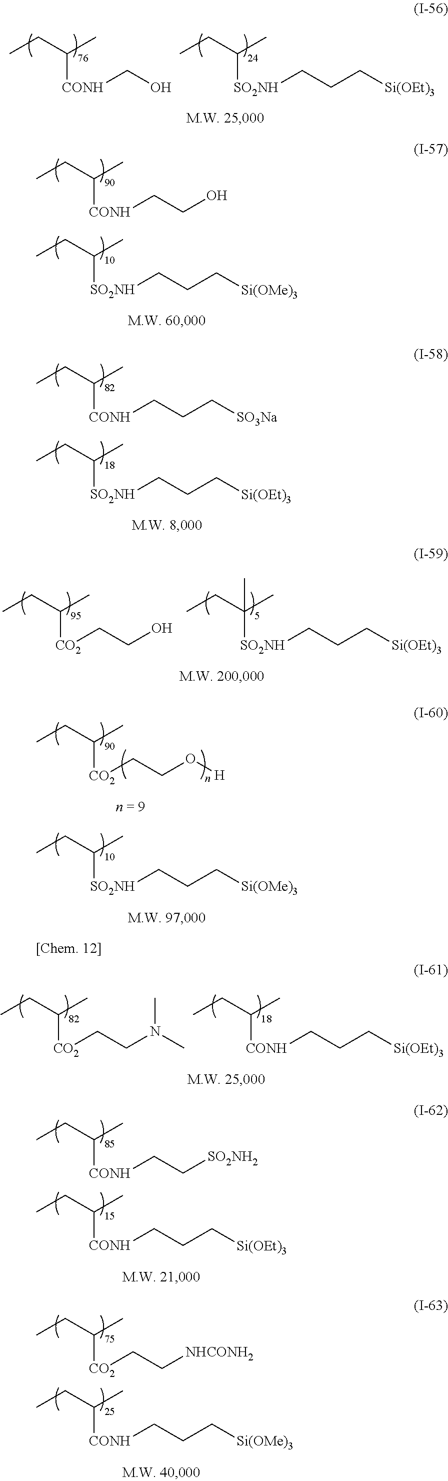

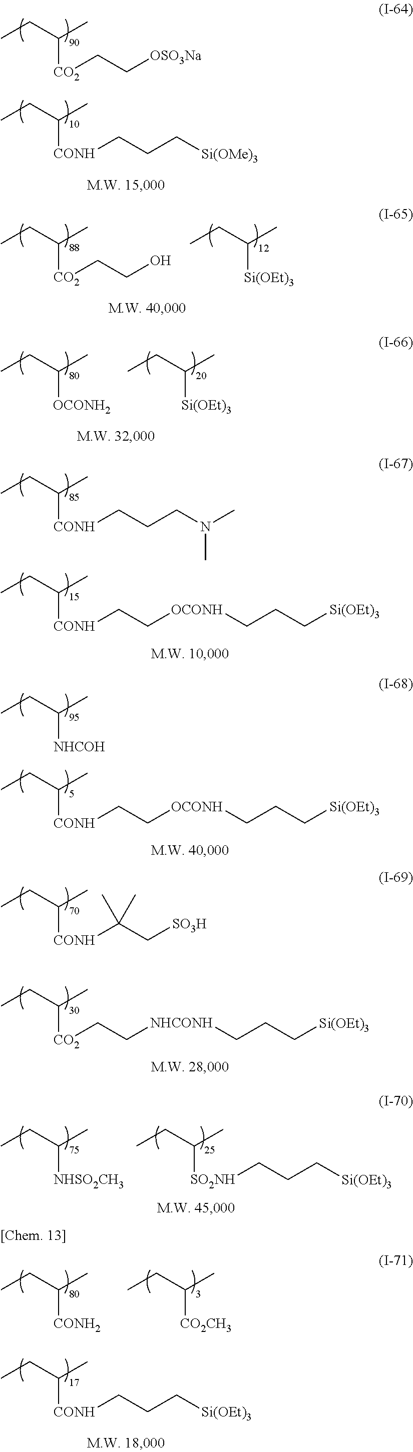

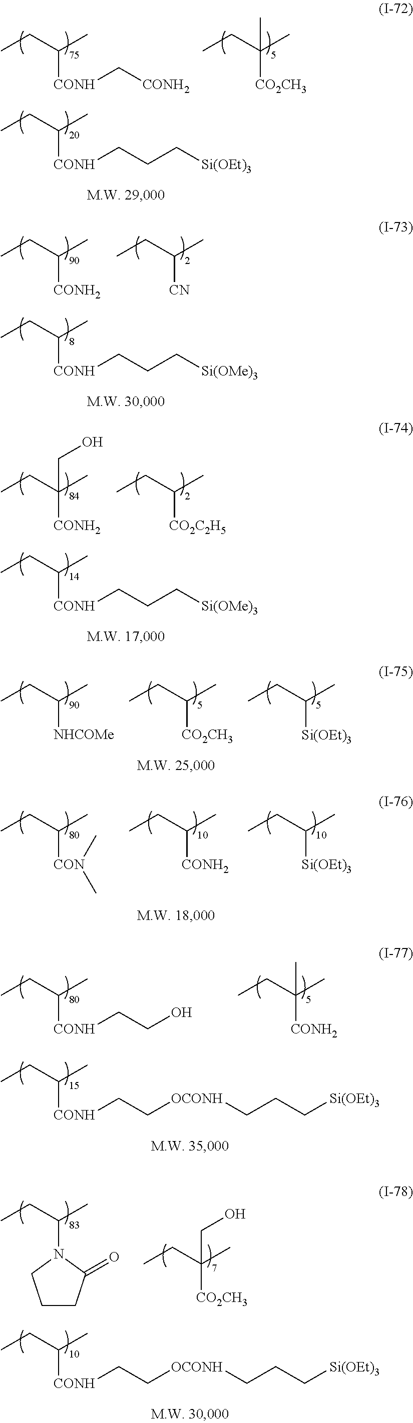

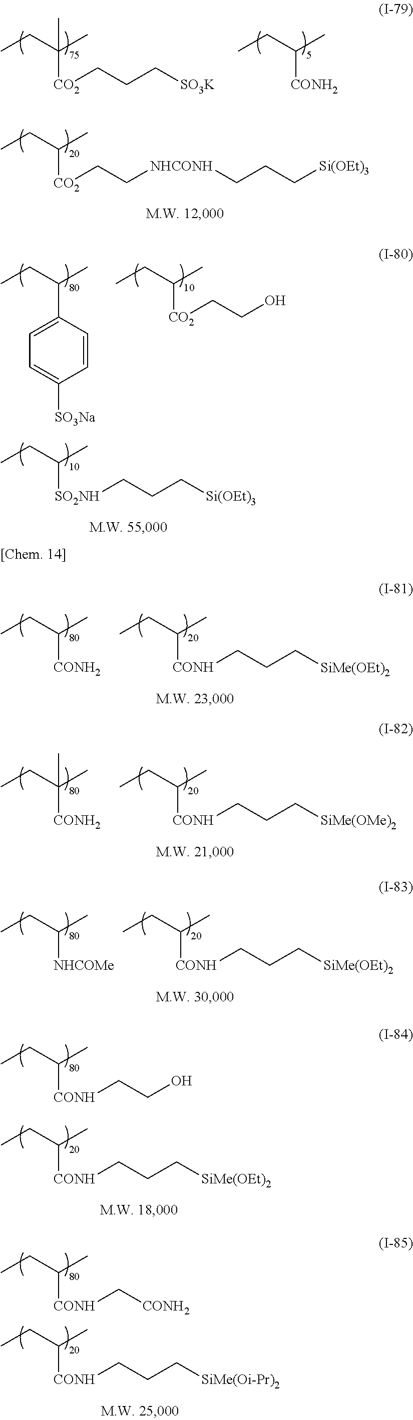

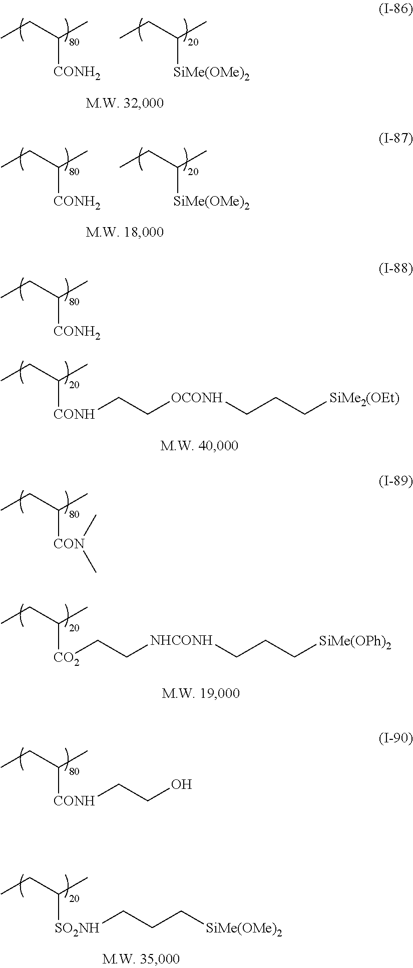

Respective compounds for synthesizing the hydrophilic polymer containing the structure represented by the general formula (I-1) and the general formula (I-2) are commercially available, and also can readily be synthesized.

As the radical polymerization for synthesizing the hydrophilic polymer containing the structure represented by the general formula (I-1) and the general formula (I-2), any of conventionally known methods can be used.

Specifically, general radical polymerization methods are described in, for example, Shin Kobunshi Jikken-gaku 3 (edited by Kyoritsu Shuppan in year 1996), Kobunshi No Gosei To Hanno 1 (compiled by The Society of Polymer Science and published by Kyoritsu Shuppan in year 1992); Shin Jikken Kagaku Koza 19 (edited by Maruzen in year 1978), Kobunshi Kagaku (I) (edited by The Chemical Society of Japan, Maruzen, 1996); and Busshitus Kogaku Koza, Kobunshi Gosei Kagaku (the publishing department of Tokyo Denki University in year 1995), and these methods can be employed.

[(B) Additives having Antibacterial or Antifungal Property]

The hydrophilic composition in the invention contains an additive having antibacterial or antifungal property in an amount exceeding 10 mass % with respect to the total solids content of the hydrophilic composition.

Examples of a species of bacteria include generally-known ones such as Staphylococcus aureus, Escherichia coli, salmonellae, Candida albicans, Trichophyton rubrum and Pseudomonas aeruginosa, and examples of a species of fungi include generally-known ones such as Penicillium, black fungi, Cladosporium Cladosporioides, Aspergillus niger, Chaetomium, yellow fungi, Rhizopus nigricans and powdery fungi. As additives for preventing the growth of those bacteria and fungi, there are compounds as recited below, and they can be used in the invention. Examples of such compounds include organic, inorganic and naturally-occurring antibacterial agents or antifungal agents and, though those well-known as such agents can be used in the invention without any restrictions, some examples of them are given below. And compounds causing no degradation in hydrophilic properties of the hydrophilic member are preferably used.

It is preferable that the additive having antibacterial or antifungal property contains at least one compound selected from a water-soluble or water-dispersible organic compound and silver-based inorganic compounds.

Examples of an additive having antibacterial or antifungal property include an organic antibacterial/antifungal agent, an inorganic antibacterial/antifungal agent and a naturally-occurring antibacterial/antifungal agent.

For instance, as for the antibacterial or antifungal agent which can be used in the invention, antibacterial or antifungal agents described in Koukin Boukabi Gijutsu, published by Toray Research Center Inc., can be used in the invention.

The examples of such agents are described as below.

### (Organic Antibacterial/Antifungal Agent)

Examples of an organic antibacterial/antifungal agent include phenol ether based compound, imidazole based compound, sulfone based compound, N-haloalkylthio compound, anilide based compound, pyrrole based compound, quaternary ammonium salt, arsine based compound, pyridine based compound, triazine based compound, benzisothiazoline based compound and isothiazoline based compound.

Specific examples thereof include 2-(4-thiocyanomethyl)benzimidazole, 1,2-benzothiazolone, 1,2-benzisothiazolin-3-one, N-fluorodichloromethylthiophthalimide, 2,3,5,6-tetra-chloroisophthalonitrile, N-trichloromethylthio-4-cyclohexene-1,2-dicarboxyimide, copper 8-quinolinate, bis(tributyltin) oxide, 2-(4-thiazolyl)benzimidazole (hereinafter referred to as “TBZ”), methyl 2-benzimidazole carbamate (hereinafter referred to as “BCM”), 10,10′-oxybisphenoxy arsine (hereinafter referred to as “OBPA”), 2,3,5,6-tetrachloro-4-(methylsulfone)pyridine, bis(2-pyridylthio-1-oxide)zinc (hereinafter referred to as “ZPT”), N,N-dimethyl-N′-(fluorodichloromethylthio)-N′-phenylsulfamide(dichlorofluanide), poly(hexamethylenebiguanide)hydrochloride, dithio-2,2′-bis(benz-methylamide), 2-methyl-4,5-trimethylene-4-isothiazolin-3-one, 2-bromo-2-nitro-1,3-propanediol, hexahydro-1,3-tris(2-hydroxyethyl)-s-triazine, p-chloro-m-xylenol, 1,2-benzisothiazolin-3-one, and methylphenol.

These antibacterial/antifungal agents can be properly chosen and used while taking into consideration hydrophilicity, water resistance, subliming property, safety and so on. As the organic antibacterial/antifungal agents, 2-(4-thiocyanomethyl)benzimidazole, 1,2-benzothiazolone, methylphenol, TBZ, BCM, OBPA or ZPT are preferred in view of hydrophilicity, antibacterial/antifungal effect, and cost.

### (Inorganic Antibacterial/Antifungal Agent)

Mercury, silver, copper, zinc, iron, lead, bismuth and so on can be exemplified in the order of a high sterilization effect and antifungal effect. Examples thereof include agents obtained by supporting a metal (for example, silver, copper, zinc, or nickel) or a metal ion thereof on a silicate based carrier, a phosphate based carrier, an oxide, glass, potassium titanate, a carboxylic acid, an amino acid, etc. More specifically, examples of such an agent include zeolite-based antibacterial/antifungal agents, calcium silicate-based antibacterial/antifungal agents, zirconium phosphate-based antibacterial/antifungal agents, calcium phosphate-based antibacterial/antifungal agents, zinc oxide-based antibacterial/antifungal agents, soluble glass-based antibacterial/antifungal agents, silica gel-based antibacterial/antifungal agents, activated carbon-based antibacterial/antifungal agents, titanium oxide-based antibacterial/antifungal agents, titania-based antibacterial/antifungal agents, organometallic antibacterial/antifungal agents, organic antibacterial/antifungal agents, ion exchanger ceramics-based antibacterial/antifungal agents, stratiform phosphate-quaternary ammonium salt-based antibacterial/antifungal agents and antibacterial/antifungal stainless steel. Among them, silver-based inorganic antibacterial/antifungal agents and water-soluble organic antibacterial/antifungal agents are preferable to the others. In particular, silver zeolite (silicate-based silver zeolite) wherein silver is supported on a silicate based carrier of zeolite, an agent wherein silver is supported on silica gel, and silver behenate are preferred.

### (Naturally-Occurring Antibacterial/Antifungal Agent)

There is chitosan which is a basic polysaccharide prepared by hydrolysis of chitin present in crustaceans, such as crabs and shrimps, or the like. A trade name of “HOLON KILLER BEADS CELLER”, a product of Nikko Co., which is composed of an amino metal having a metal bonded to both sides of an amino acid, is preferred.

It is preferable that the additive having antibacterial or antifungal property contains at least one compound selected from an imidazole based compound, an arsine based compound, a pyridine based compound and a silver-based compound.

It is more preferable that the additive having antibacterial or antifungal property contains at least one compound selected from 2-(4-thiazolyl)benzimidazole, methyl 2-benzimidazole carbamate, 10,10′-oxybisphenoxyarsine, bis(2-pyridylthio-1-oxide)zinc, silicate-based silver zeolite and silver behenate.

Of these compounds, bis(2-pyridylthio-1-oxide)zinc (abbreviated as “ZPT”) is especially preferred.

Owing to high compatibility of those additives with the present hydrophilic composition and their uniform dispersion into hydrophilic coatings, elution of antifungal agents into water is not caused by water-resistance testing, and therefore the present hydrophilic composition can ensure excellent antifungal property even after the water-resistance testing.

Additives having antibacterial and antifungal property are incorporated in an amount exceeding 10 mass % of the total solids, and their content is preferably from 15 mass % to 70 mass %, more preferably from 20 mass % to 70 mass %, most preferably from 20 mass % to 60 mass %. Excellent antibacterial/antifungal effects can be produced so long as the content is higher than 10 mass %; while, as long as the content is 70 mass % or lower, sufficient antibacterial/antifungal function can be shown without lowering in hydrophilicity. Additionally, one or more than one kind of the additive having antibacterial/antifungal property may be incorporated in the hydrophilic composition.

Evaluation of antibacterial effect can be made in conformity with JIS Z 2801 (antibacterial products—antibacterial property testing method/antibacterial effect). On the other hand, evaluation of antifungal effect can be made in conformity with JIS Z 2911 (fungi resistance testing).

It is preferable that the hydrophilic composition further contains a hydrophilic polymer (II) which includes a structure represented by the following general formula (II-1) and the following general formula (II-2).

### [(A) Hydrophilic Polymer (II) Containing the Structural Unit Represented by the General Formula (II-1) and the General Formula (II-2)]

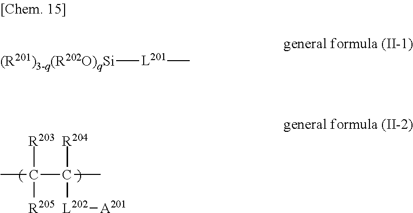

In the general formulae (II-1) and (II-2), R²⁰¹ to R²⁰⁵ each independently represents a hydrogen atom or a hydrocarbon group. q represents an integer of from 1 to 3, and L²⁰¹ and L²⁰² each represents a single bond or a polyvalent organic linking group. A²⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ). Here, Rₐ, R_{b}, and R_{c} each independently represents a hydrogen atom or a straight, branched or cyclic alkyl group, R_{d} represents a straight, branched or cyclic alkyl group, Rₑ and R_{f} each independently represents a hydrogen atom, a straight, branched or cyclic alkyl group, an alkali metal, an alkaline earth metal or an onium, and R_{g} represents a halogen ion, an inorganic anion or an organic anion.

The hydrophilic polymer (II) containing the structural represented by the general formula (II-1) and the general formula (II-2) preferably has the structural unit represented by the above general formula (II-2) and preferably has the partial structure represented by the above general formula (II-1) at the end of the polymer chain.

In the foregoing general formulae (II-1) and (II-2), R²⁰¹ to R²⁰⁵ each independently represents a hydrogen atom or a hydrocarbon group. As the hydrocarbon group when R²⁰¹ to R²⁰⁵ each represents a hydrocarbon group, there are illustrated an alkyl group, an aryl group, and the like, with a straight, branched or cyclic alkyl group containing from 1 to 8 carbon atoms being preferred. Specifically, there can be illustrated similar ones that have been illustrated hereinbefore with respect to R¹⁰¹ to R¹⁰⁸ in the foregoing general formulae (I-1) and (I-2).

L²⁰¹ and L²⁰² each independently represents a single bond or a polyvalent organic linking group. Here, the term “single bond” means that the main chain of the polymer is directly connected to A²⁰¹ or Si atom without any linking group. In the case where L²⁰¹ and L²⁰² each represents a polyvalent organic linking group, specific examples and preferred examples thereof are similar to those which have been illustrated with respect to L¹⁰¹ in the foregoing general formula (I-1).

A²⁰¹ represents —OH, —ORₐ, —CORₐ, —CO₂Rₑ, —CON(Rₐ)(R_{b}), —N(Rₐ)(R_{b}), —NHCOR_{d}—, —NHCO₂Rₐ, —OCON(Rₐ)(R_{b}), —NHCON(Rₐ)(R_{b}), —SO₃Rₑ, —OSO₃R_{c}, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ). Specific examples and preferred examples of A²⁰¹ are similar to those which have been illustrated with respect to A¹⁰¹ in the foregoing general formula (I-2).

q represents an integer of from 1 to 3, preferably 2 or 3, more preferably 3.

L²⁰¹ and L²⁰² more preferably represent —CH₂CH₂CH₂—S—, —CH₂S—, —CONHCH(CH₃)CH₂—, —CONH—, —CO—, —CO₂—, and —CH₂—.

The hydrophilic polymer containing the structures represented by the general formulae (II-1) and (II-2) can be synthesized by, for example, radical polymerization of a hydrophilic monomer (for example, acrylamide, acrylic acid, or a potassium salt of 3-sulfopropyl methacrylate) in the presence of a chain transfer agent (described in Kanji Kamachi and Tsuyoshi Endo, Radical Polymerization Handbook, NTS) or Iniferter (described in Macromolecules, 1986, 19, pages 287, et seq., Otsu). Examples of the chain transfer agent include 3-mercaptopropionic acid, 2-aminoethanethiol hydrochloride, 3-mercaptopropanol, 2-hydroxyethyl disulfide, and 3-mercaptopropyl trimethoxysilane. Also, a hydrophilic monomer (for example, acrylamide) may be radical polymerized by using a radical polymerization initiator having a reactive group without using a chain transfer agent.

The hydrophilic polymer containing the structural represented by the general formula (II-1) and the general formula (II-2) can be synthesized by radical polymerization of a radical polymerizable monomer represented by the following general formula (i) by using a silane coupling agent having chain transfer ability in radical polymerization as represented by the following formula (ii). Since the silane coupling agent (ii) has chain transfer ability, a polymer in which a silane coupling group is introduced in an end of the main chain of the polymer in the radical polymerization can be synthesized.

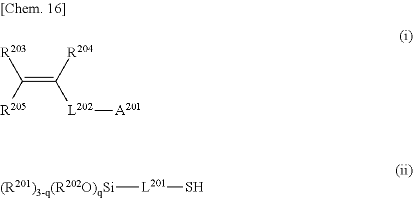

In the above general formulae (i) and (ii), R²⁰¹ to R²⁰⁵, L²⁰¹, L²⁰², A²⁰¹, and q are the same as those in the foregoing general formula (II-1). These compounds are commercially available or can be readily synthesized. The radical-polymerizable monomer represented by the general formula (i) contains a hydrophilic group A²⁰¹, and this monomer constitutes one structural unit in the hydrophilic polymer.

In the hydrophilic polymer (II) containing the structural represented by the general formula (II-1) and the general formula (II-2), the mol number of the structural unit of the general formula (II-2) is preferably from 1000 to 10 times, more preferably from 500 to 20 times, most preferably from 200 to 30 times, as much as the mol number of the hydrolyzable silyl group amount-containing structural unit represented by the general formula (II-1). When the mol number of the structural unit of the general formula (II-2) is at least 30 times as much as that of the structural unit of the general formula (II-1), sufficient hydrophilicity can be obtained whereas, when the mol number of the structural unit of the general formula (II-2) is not more than 200 times as much as that of the structural unit of the general formula (II-1), the amount of the hydrolyzable silyl group becomes enough to provide sufficient hardness and sufficient film strength.

The mass-average molecular weight of the hydrophilic polymer (II) containing the structure represented by the general formula (II-1) and the general formula (II-2) is preferably from 1,000 to 1,000,000, more preferably from 1,000 to 500,000, most preferably from 1,000 to 200,000.

Specific examples of the hydrophilic polymer (II) which can preferably be used in the invention will be described below. However, the invention is not limited by them at all. In the specific examples, * shows the point of attachment to the polymer.

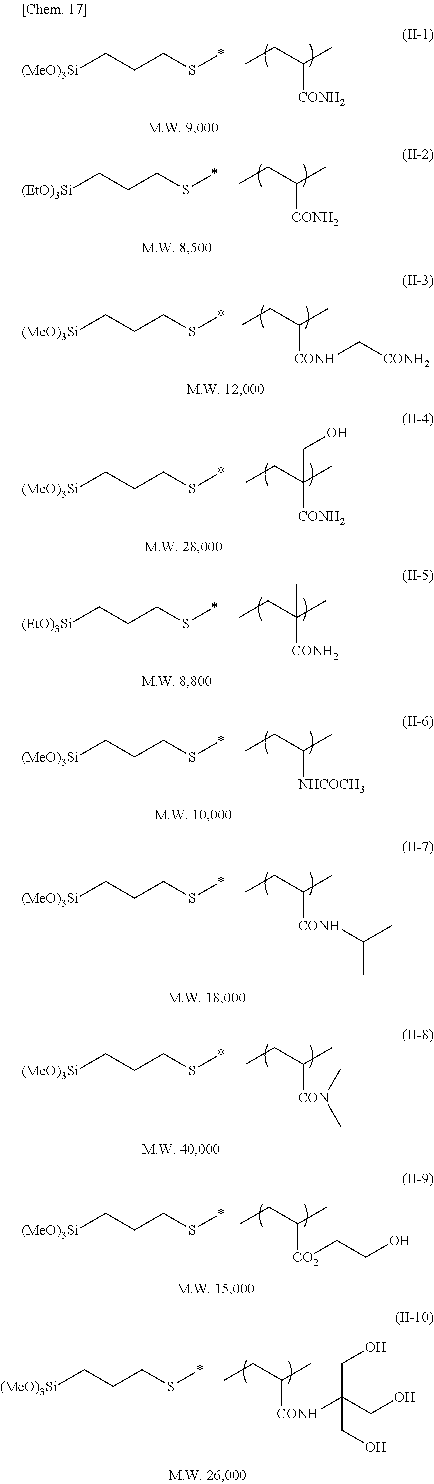

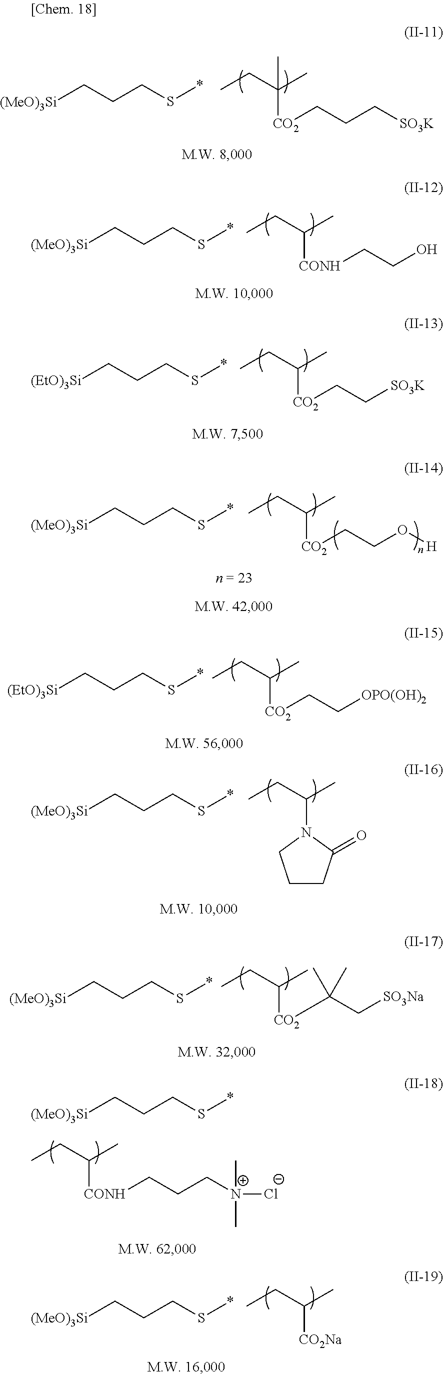

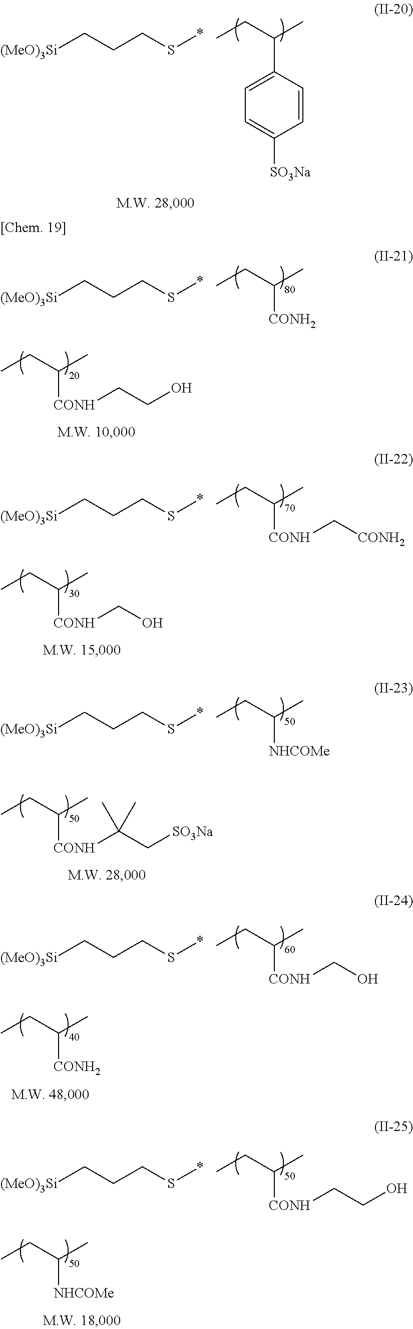

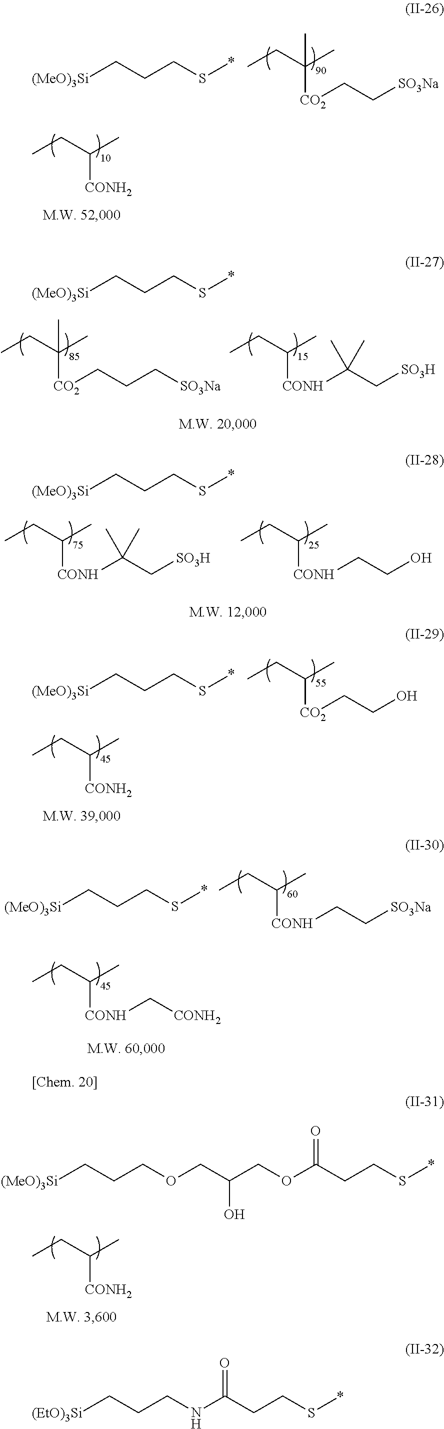

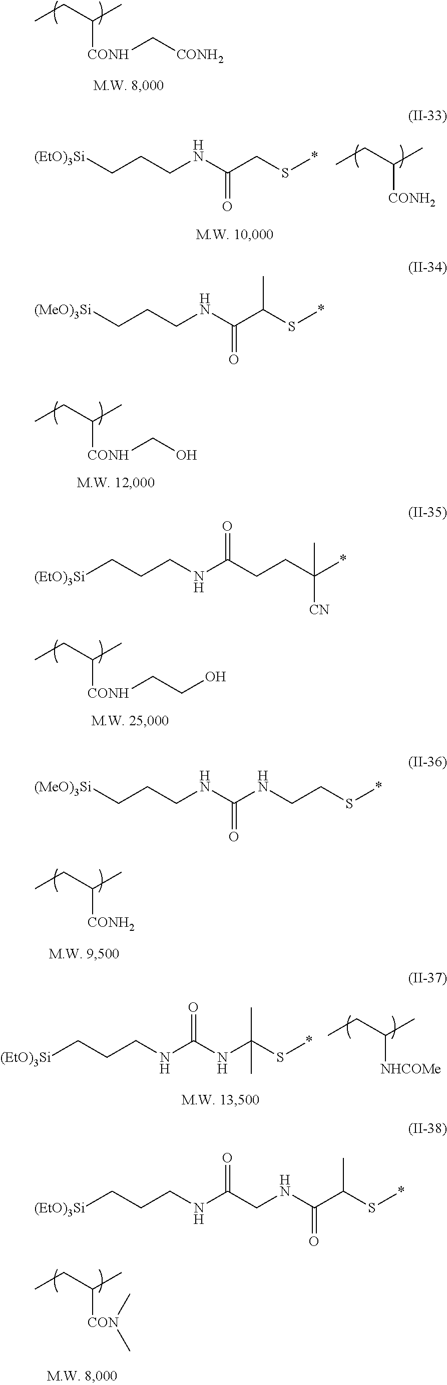

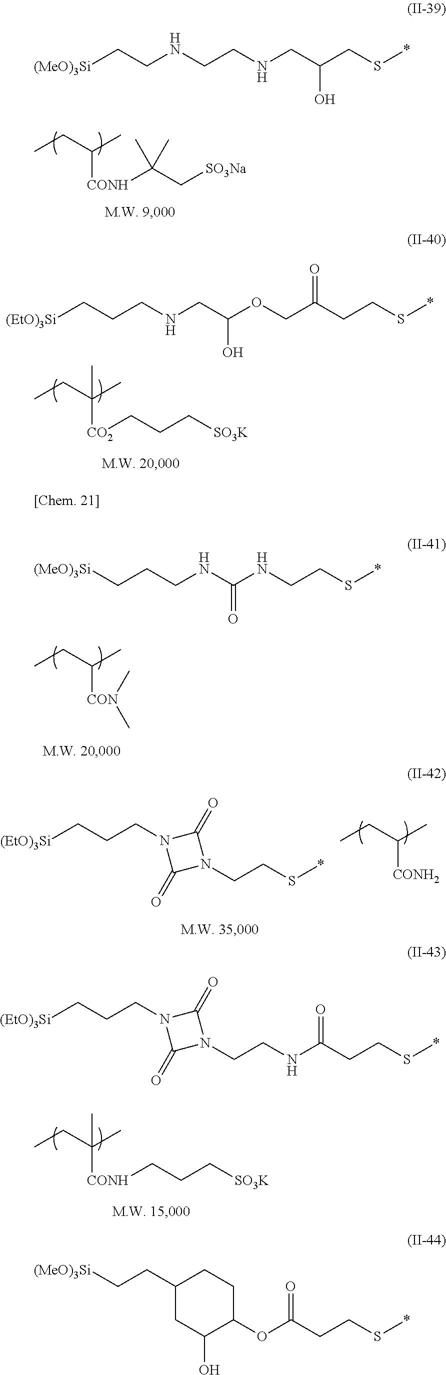

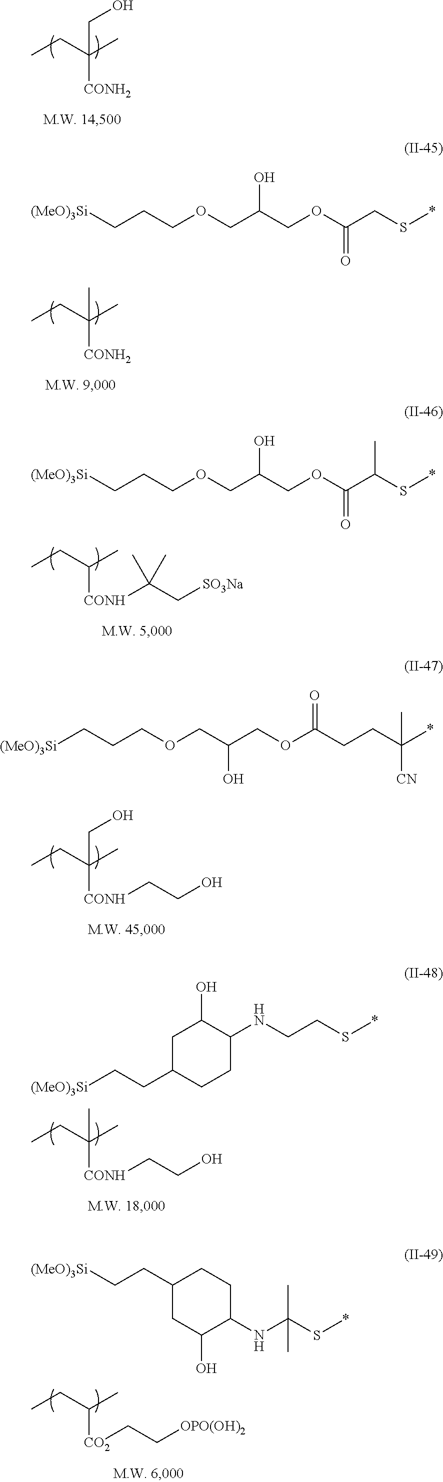

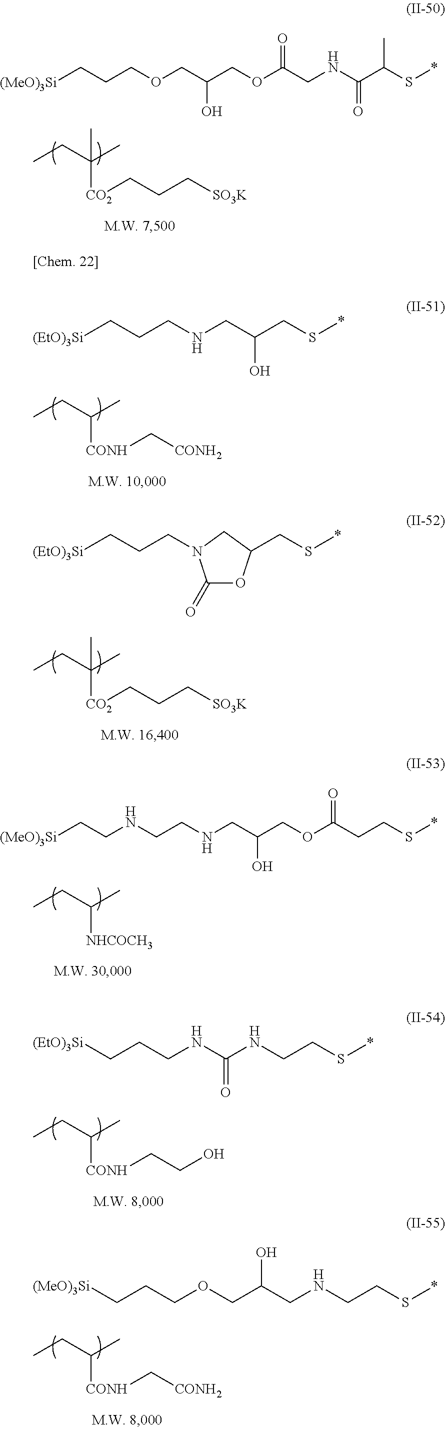

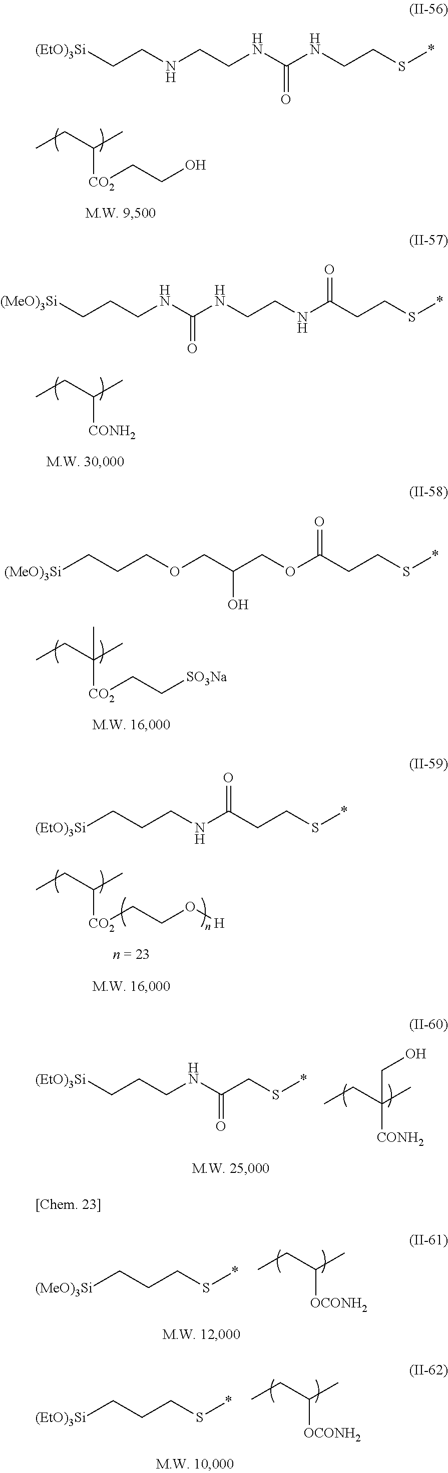

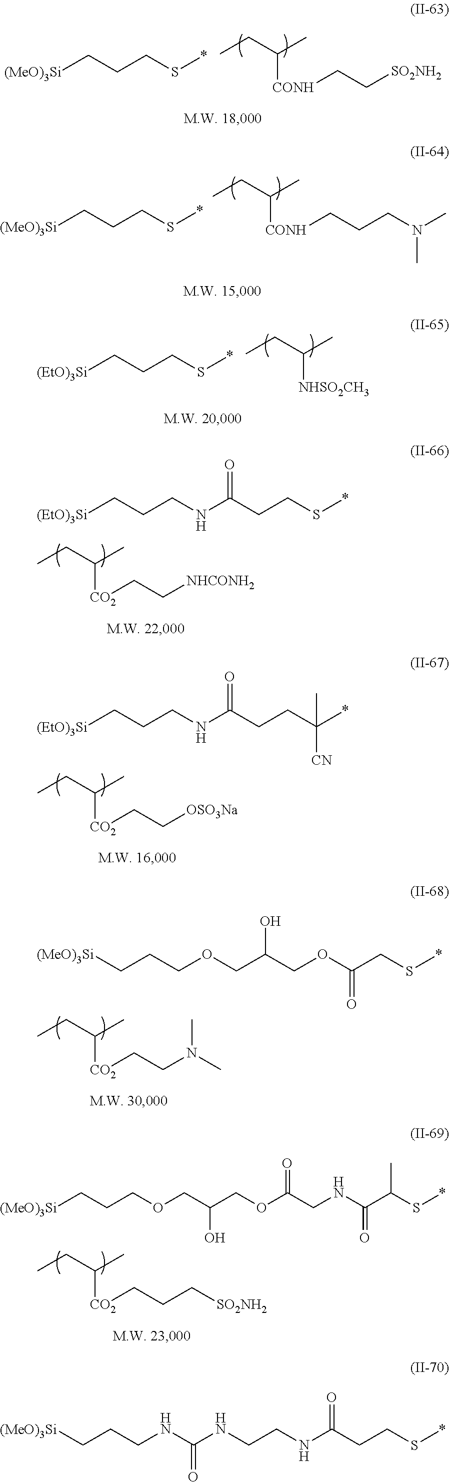

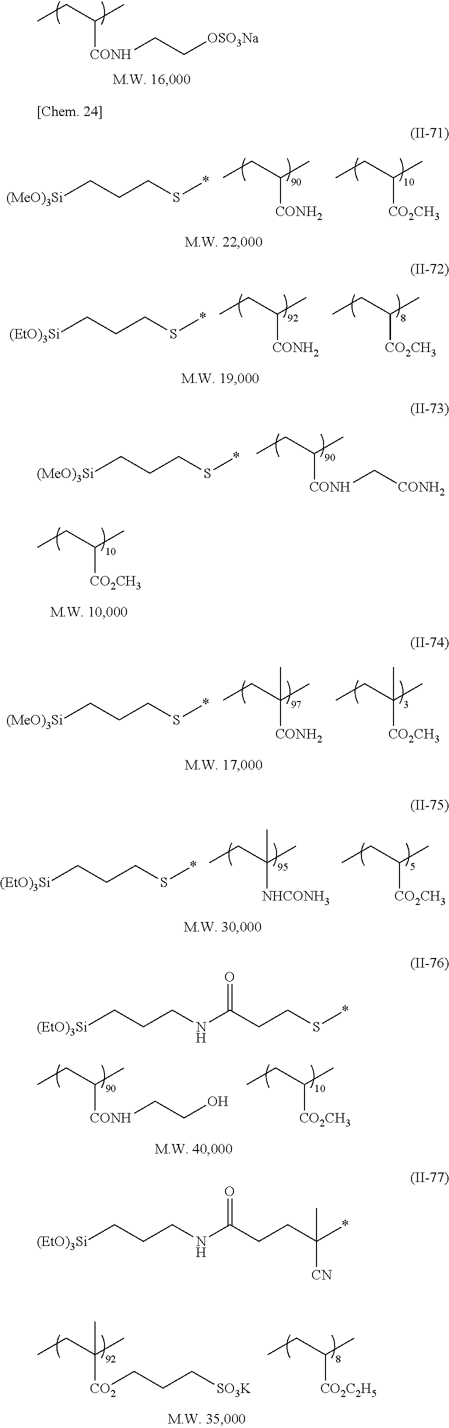

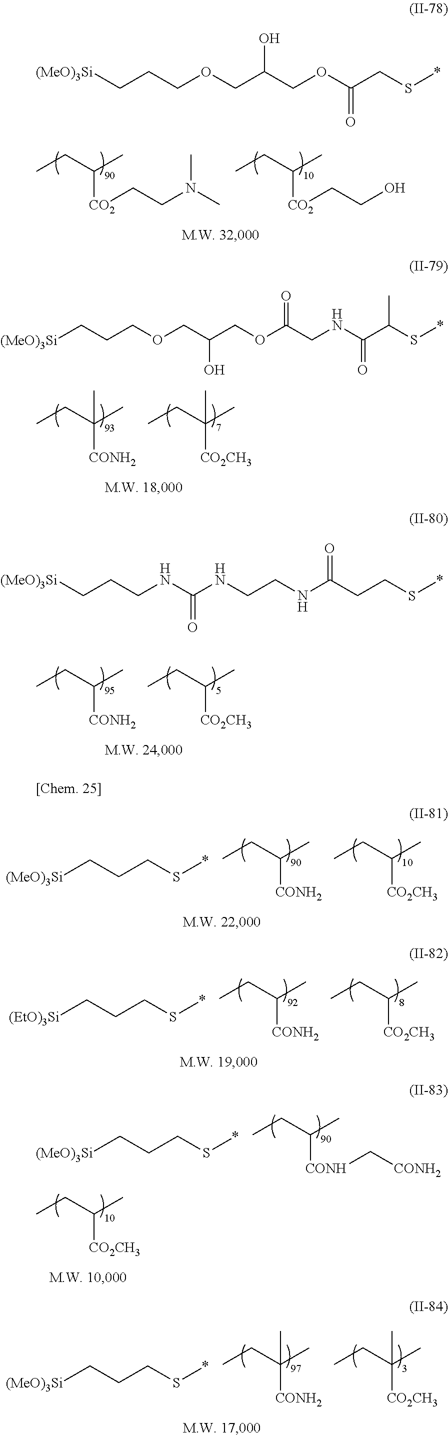

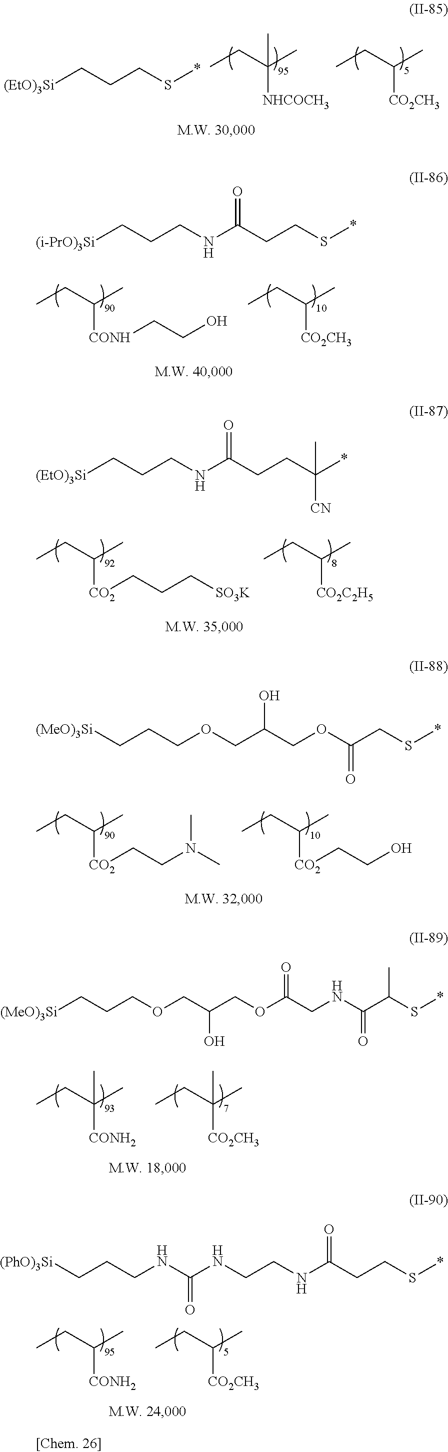

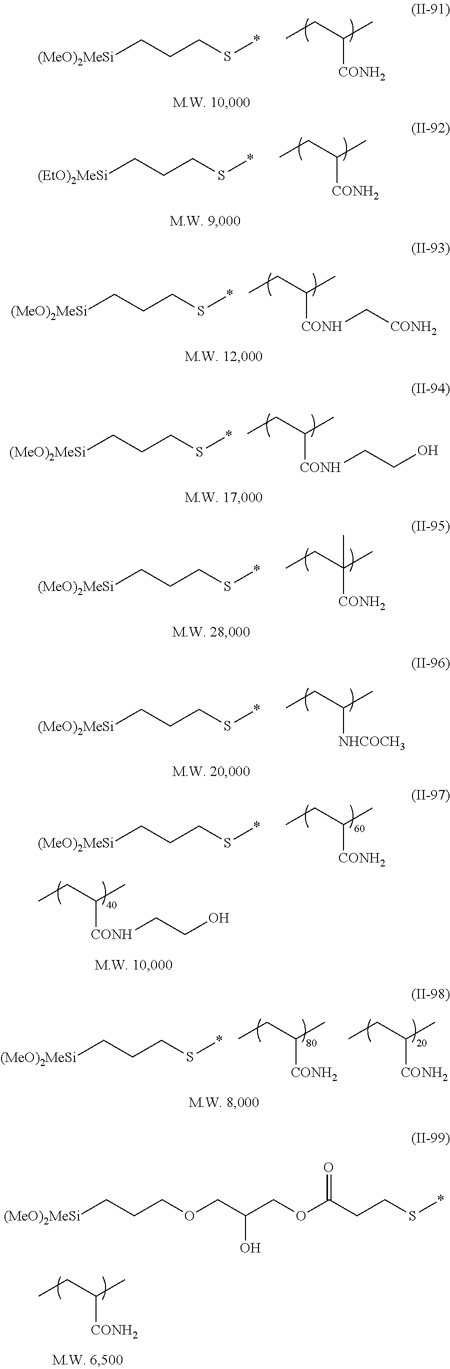

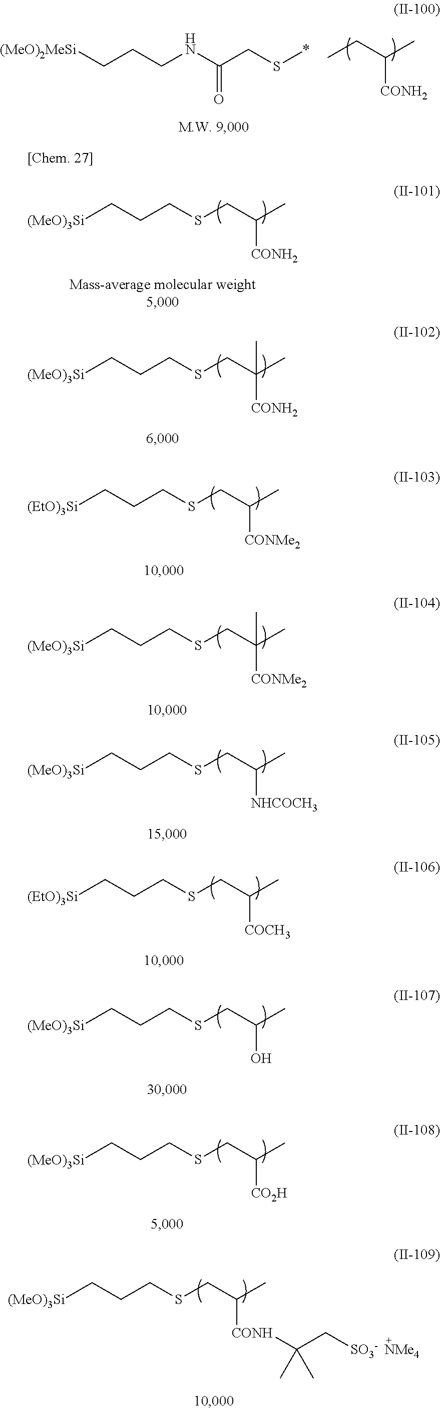

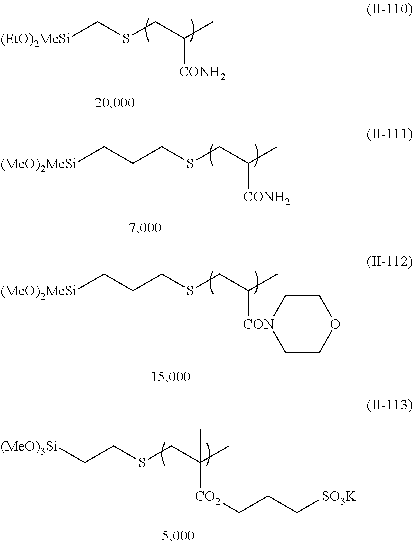

The mass ratio of the hydrophilic polymer (I) to the hydrophilic polymer (II), being contained in the hydrophilic composition, (hydrophilic polymer (I)/hydrophilic polymer (II)) is preferably in a range of 50/50 to 95/5.

The hydrophilic polymer (I) or (II) may be a copolymer with other monomer. As the other monomers to be used, there are also illustrated known monomers such as acrylic acid esters, methacrylic acid esters, acrylamides, methacrylamides, vinyl esters, styrenes, acrylic acid, methacrylic acid, acrylonitrile, maleic anhydride, maleimide, etc. Various physical properties such as film-forming properties, film strength, hydrophilicity, hydrophobicity, solubility, reactivity, stability, etc. can be improved by copolymerizing these monomers.

As specific examples of the acrylic acid esters, there are illustrated methyl acrylate, ethyl acrylate, (n- or i-)propyl acrylate, (n-, i-, sec- or t-)butyl acrylate, amyl acrylate, 2-ethylhexyl acrylate, dodecyl acrylate, chloroethyl acrylate, 2-hydroxyethyl acrylate, 2-hydroxypropyl acrylate, 2-hydroxypentyl acrylate, cyclohexyl acrylate, allyl acrylate, trimethylolpropane monoacrylate, pentaerythritol monoacrylate, benzyl acrylate, methoxybenzyl acrylate, chlorobenzyl acrylate, hydroxybenzyl acrylate, hydroxyphenethyl acrylate, dihydroxyphenethyl acrylate, furfuryl acrylate, tetrahydrofurfuryl acrylate, phenyl acrylate, hydroxyphenyl acrylate, chlorophenyl acrylate, sulfamoylphenyl acrylate, 2-(hydroxyphenylcarbonyloxy)ethyl acrylate, etc.

As specific examples of the methacrylic acid esters, there are illustrated methyl methacrylate, ethyl methacrylate, (n- or i-)propyl methacrylate, (n-, i-, sec- or t-)butyl methacrylate, amyl methacrylate, 2-ethylhexyl methacrylate, dodecyl methacrylate, chloroethyl methacrylate, 2-hydroxyethyl methacrylate, 2-hydroxypropyl methacrylate, 2-hydroxypentyl methacrylate, cyclohexyl methacrylate, allyl methacrylate, trimethylolpropane monomethacrylate, pentaerythritol monomethacrylate, benzyl methacrylate, methoxybenzyl methacrylate, chlorobenzyl methacrylate, hydroxybenzyl methacrylate, hydroxyphenethyl methacrylate, dihydroxyphenethyl methacrylate, furfuryl methacrylate, tetrahydrofurfuryl methacrylate, phenyl methacrylate, hydroxyphenyl methacrylate, chlorophenyl methacrylate, sulfamoylphenyl methacrylate, 2-(hydroxyphenylcarbonyloxy)ethyl methacrylate, etc.

As specific examples of the acrylamides, there are illustrated acrylamide, N-methylacrylamide, N-ethylacrylamide, N-propylacrylamide, N-butylacrylamide, N-benzylacrylamide, N-hydroxyethylacrylamide, N-phenylacrylamide, N-tolylacrylamide, N-(hydroxyphenyl)acrylamide, N-(sulfamoylphenyl)acrylamide, N-(phenylsulfonyl)acrylamide, N-(tolylsulfonyl)acrylamide, N,N-dimethylacrylamide, N-methyl-N-phenylacrylamide, N-hydroxyethyl-N-methylacrylamide, etc.

As specific examples of the methacrylamides, there are illustrated methacrylamide, N-methylmethacrylamide, N-ethylmethacrylamide, N-propylmethacrylamide, N-butylmethacrylamide, N-benzylmethacrylamide, N-hydroxyethylmethacrylamide, N-phenylmethacrylamide, N-tolylmethacrylamide, N-(hydroxyphenyl)methacrylamide, N-(sulfamoylphenyl)methacrylamide, N-(phenylsulfonyl)methacrylamide, N-(tolylsulfonyl)methacrylamide, N,N-dimethylmethacrylamide, N-methyl-N-phenylmethacrylamide, N-hydroxyethyl-N-methylmethacrylamide, etc.

As specific examples of the vinyl esters, there are illustrated vinyl acetate, vinyl butyrate, vinyl benzoate, etc.

As specific examples of the styrenes, there are illustrated styrene, methylstyrene, dimethylstyrene, trimethylstyrene, ethylstyrene, propylstyrene, cyclohexylstyrene, chloromethylstyrene, trifluoromethylstyrene, ethoxymethylstyrene, acetoxymethylstyrene, methoxystyrene, dimethoxystyrene, chlorosyrene, dichlorostyrene, bromostyrene, iodostyrene, fluorostyrene, carboxystyrene, etc.

The proportion of these other monomers to be used in synthesis of the copolymer must be at an enough level to improve various properties but, in order to exhibit sufficient functions as a hydrophilic film and obtain sufficient advantages of adding the specific hydrophilic polymer (I) and the specific hydrophilic polymer (II), the proportion is preferably not so large. Therefore, the total proportion of the other monomers in the specific hydrophilic polymer (I) and the specific hydrophilic polymer (II) is preferably 80 mass % or less, more preferably 50 mass % or less.

Measurement of the copolymerization ratio of the hydrophilic polymer (I) or (II) can be conducted by means of a nuclear magnetic resonance apparatus (NMR), or by means of an infrared spectrometer with preparing a calibration curve by use of standard substances.

It is also possible to use the hydrophilic polymer (I) or (II) alone or as a mixture thereof in the hydrophilic composition of the invention.

In view of curability and hydrophilicity, the hydrophilic polymer (I) or (II) is used in an amount of preferably from 20 to 99.5 mass %, more preferably from 30 to 99.5 mass %, based on all the solid components in the hydrophilic composition.

The above-described hydrophilic polymers form a cross-linked film in a state of a mixture with a product of hydrolysis and polycondensation of a metal alkoxide. The hydrophilic polymer which is an organic component participates in film strength and film flexibility. In particular, when the hydrophilic polymer has a viscosity of from 0.1 to 100 mPa·s (5 mass % aqueous solution; measured at 20° C.), preferably from 0.5 to 70 mPa·s, still more preferably from 1 to 50 mPa·s, there results good film properties.

### [(C) Cross-Linking Agent]

When the hydrophilic composition contains the hydrophilic polymer (II), addition of a cross-linking agent thereto is suitable for imparting satisfactory curability to the composition. On the other hand, when the hydrophilic composition contains the hydrophilic polymer (I), it can have satisfactory curability even if no cross-linking agent is added thereto. In order to provide coatings outstanding for film strength, however, the composition may contain a cross-linking agent.

As to the cross-linking agent, an alkoxide compound containing a element selected from Si, Ti, Zr and Al (also referred to as a metal alkoxide) is especially preferred. The metal alkoxide is a hydrolytically polymerizing compound which contains in its structure a functional group capable of effecting polycondensation through hydrolysis and functions as a cross-linking agent, and forms a tough cross-linked film having a cross-linked structure through polycondensation between molecules thereof, and it can also form chemical bonds to the hydrophilic polymers. The metal alkoxide can be represented by the following general formula (V-1) or (V-2). In these formulae, R²⁰ represents a hydrogen atom, an alkyl group or an aryl group, R²¹ and R²² represent an alkyl group or an aryl group, Z represents Si, Ti or Zr, and m represents an integer of from 0 to 2. When R²⁰ and R²¹ represent an alkyl group, the number of carbon atoms in the alkyl group is preferably from 1 to 4. The alkyl group or the aryl group may have a substituent, and examples of a substituent which can be introduced into such a group include a halogen atom, an amino group and a mercapto group. Additionally, this compound is a low molecular compound, and the molecular weight thereof is preferably 2,000 or below.

(R²⁰)ₘ—Z—(OR²¹)₄₋ₘ (V-1)

Al—(OR²²)₃ (V-2)

Specific examples of the metal alkoxide represented by the general formula (V-1) or the general formula (V-2) will be given below, but the invention is not limited thereto.

In the case where Z represents Si, that is, silicon is contained in the hydrolyzable compound, examples thereof include trimethoxysilane, tetramethoxysilane, tetraethoxysilane, tetrapropoxysilane, methyltrimethoxysilane, dimethyldimethoxysilane, γ-chloropropyltriethoxysilane, γ-mercaptopropyltrimethoxysilane, γ-aminopropyltriethoxysilane, phenyltrimethoxysilane, and diphenyldiethoxysilane. Of these, trimethoxysilane, tetramethoxysilane, tetraethoxysilane, methyl-trimethoxysilane, dimethyldimethoxysilane, and phenyltrimethoxysilane are particularly preferred.

In the case where Z represents Ti, that is, titanium is contained in the hydrolyzable compound, examples thereof include trimethoxy titanate, tetramethoxy titanate, triethoxy titanate, tetraethoxy titanate, tetrapropoxy titanate, chlorotrimethoxy titanate, chlorotriethoxy titanate, ethyltrimethoxy titanate, methyltriethoxy titanate, ethyltriethoxy titanate, diethyldiethoxy titanate, phenyltrimethoxy titanate, and phenyltriethoxy titanate. In the case where Z represents Zr, namely zirconium is contained in the hydrolyzable compound, examples thereof include zirconates corresponding to the above-exemplified titanium-containing compounds.

Also, in the case where the center metal is Al, that is, aluminum is contained in the hydrolyzable compound, examples thereof include trimethoxy aluminate, triethoxy aluminate, tripropoxy aluminate, and triisopropoxy aluminate.

Of the compounds recited above, tetramethoxysilane, tetraethoxysilane, methyltrimethoxysilane and methyltriethoxysilane are preferred over the others.

In the case of using a hydrophilic polymer having a structure represented by the general formula (I), the metal alkoxide compound whose metal is selected from Si, Ti, Zr and Al is added in an amount of preferably from 0 to 80 mass %, more preferably from 0 to 70 mass %, with respect to the total solids content of the hydrophilic composition. In the case of using a hydrophilic polymer having a structure represented by the general formula (II), such a metal alkoxide compound is added in an amount of preferably from 0 to 80 mass %, more preferably from 0 to 70 mass %, with respect to the total solids content of the hydrophilic composition.

### [(D) Catalyst]

In the hydrophilic composition of the invention, by dissolving the hydrophilic polymer (I) (A), the additive (B) having antifungal action and, preferably further, the hydrophilic polymer (II) (A), and a cross-linking component such as the cross-linking agent (C) in a solvent and well stirring the solution, these components are hydrolyzed and polycondensed to form an organic/inorganic hybrid sol liquid, and a hydrophilic film having high hydrophilicity and high film strength is formed by this sol liquid. In preparing the organic/inorganic hybrid sol liquid, it is preferred to use a catalyst (D) in order to accelerate the hydrolysis and polycondensation reaction. Use of the catalyst allows to set up the drying temperature for forming the hydrophilic layer film at a low level, which serves to suppress thermal change of the antibacterial agent or thermal deformation on the substrate.

As the catalyst (D) which can be used in the invention, a catalyst capable of hydrolyzing and polycondensing the foregoing cross-linking agent (C) and accelerating a reaction for forming a linkage with the hydrophilic polymer (A) is chosen. As the catalyst (D), an acidic or basic compound is used as it is; or an acidic or basic compound is used in a state that it is dissolved in a solvent such as water and alcohols (these catalysts will be hereinafter also referred to inclusively as “acidic catalyst” and “basic catalyst”, respectively). In dissolving the acidic or basic compound in a solvent, its concentration is not particularly limited and may be properly chosen depending upon characteristics of the acidic or basic compound to be used, a desired content of the catalyst, etc. Here, in the case where the concentration of the acidic or basic compound which constitutes the catalyst is high, the rate of hydrolysis and polycondensation tends to become fast. However, when a basic catalyst of a high concentration is used, there may be a possibility that a precipitate is formed in the sol solution. Therefore, when the basic catalyst is used, its concentration is desirably not more than 1 N as calculated in terms of a concentration in the aqueous solution.

The kind of the acidic catalyst or basic catalyst is not particularly limited. When it is required to use a catalyst having a high concentration, a catalyst constituted of an element which does not substantially remain in the coating film after drying is desirable. Specifically, examples of the acidic catalyst include hydrogen halides (such as hydrochloric acid), nitric acid, sulfuric acid, sulfurous acid, hydrogen sulfide, perchloric acid, hydrogen peroxide, carbonic acid, carboxylic acids (such as formic acid and acetic acid), substituted carboxylic acids represented by the structural formula of RCOOH wherein R is substituted with other element or a substituent, and sulfonic acids (such as benzenesulfonic acid); and examples of the basic compound include ammoniacal bases (such as aqueous ammonia) and amines (such as ethylamine and aniline).

Also, in addition to the foregoing catalysts, a Lewis acid catalyst composed of a metal complex can be preferably used. Metal complexes composed of a metal element selected from Groups 2A, 3B, 4A and 5A of the periodic table, and an oxo or hydroxy oxygen-containing compound selected from β-diketones, ketoesters, hydroxycarboxylic acids and their esters, amino alcohols and enolic active hydrogen compounds are especially preferred metal complex catalysts.

Of the constituent metal elements, preferred are elements of Group 2A such as Mg, Ca, Sr, and Ba; elements of Group 3B such as Al and Ga; elements of Group 4A such as Ti and Zr; and elements of Group 5A such as V, Nb, and Ta. They may form complexes having an excellent catalytic effect. Of those, complexes with any of Zr, Al and Ti are excellent and therefore preferred.

Examples of the oxo or hydroxy oxygen-containing compound constituting the ligand of the above metal complex usable in the invention include β-diketones such as acetylacetone (2,4-pentanedione) and 2,4-heptanedione, ketoesters such as methyl acetoacetate, ethyl acetoacetate, and butyl acetoacetate, hydroxycarboxylic acids and esters thereof such as lactic acid, methyl lactate, salicylic acid, ethyl salicylate, phenyl salicylate, malic acid, tartaric acid and methyl tartrate, ketoalcohols such as 4-hydroxy-4-methyl-2-pentanone, 4-hydroxy-2-pentanone, 4-hydroxy-4-methyl-2-pentanone, and 4-hydroxy-2-heptanone, amino alcohols such as monoethanolamine, N,N-dimethylethanolamine, N-methyl-monoethanolamine, diethanolamine, and triethanolamine, enolic active compounds such as methylolmelamine, methylolurea, methylolacrylamide, and diethyl malonate, and compounds derived from acetylacetone (2,4-pentanedione) by introducing a substituent into the methyl group, the methylene group, or the carbonyl carbon thereof.

Acetylacetone or acetylacetone derivatives are preferred for the ligand. In the present invention, the term “acetylacetone derivatives” mean compounds derived from acetylacetone by introducing a substituent into the methyl group, the methylene group, or the carbonyl carbon thereof. Examples of the substituent for the methyl group of acetylacetone include linear or branched alkyl groups, acyl groups, hydroxyalkyl groups, carboxyalkyl groups, alkoxy groups, and alkoxyalkyl groups each having from 1 to 3 carbon atoms. Examples of the substituent for the methylene group of acetylacetone include carboxyl groups, and linear or branched carboxyalkyl groups and hydroxyalkyl groups, each having from 1 to 3 carbon atoms. Examples of the substituent for the carbonyl carbon of acetylacetone include alkyl groups having from 1 to 3 carbon atoms, and in this case, a hydrogen atom may be attached to the carbonyl oxygen to form a hydroxyl group.

Preferred specific examples of the acetylacetone derivative include ethylcarbonylacetone, n-propylcarbonylacetone, i-propylcarbonylacetone, diacetylacetone, 1-acetyl-1-propionyl-acetylacetone, hydroxyethylcarbonylacetone, hydroxypropylcarbonylacetone, acetoacetic acid, acetopropionic acid, diacetoacetic acid, 3,3-diacetopropionic acid, 4,4-diacetobutyric acid, carboxyethylcarbonylacetone, carboxypropylcarbonylacetone, and diacetone alcohol.

Of those, acetylacetone and diacetylacetone are especially preferred. The complex of the above acetylacetone derivative and the above metal element is a mononuclear complex having from 1 to 4 molecular ligands of the acetylacetone derivative per one metal element therein. In case where the number of the coordinable chemical bonds of the metal element is greater than the total number of the coordinable chemical bonds of the acetylacetone derivative, any ordinary ligand generally used in ordinary complexes, such as water molecule, halide ion, nitro group or ammonio group, may be coordinated in the complex.

Preferred examples of the metal complex include tris(acetylacetonato)aluminum complex, di(acetylacetonato)aluminum/aquo complex, mono(acetylacetonato)aluminum/chloro complex, di(diacetylacetonato)aluminum complex, ethylacetoacetate aluminum diisopropylate, aluminum tris(ethylacetoacetate), cyclic aluminum oxide isopropylate, tris(acetylacetonato)barium complex, di(acetylacetonato)titanium complex, tris(acetylacetonato)titanium complex, di-i-propoxy/bis(acetylacetonato)titanium complex, zirconium tris(ethylacetoacetate), and zirconium tris(benzoate) complex. They are excellent in stability in water-based coating liquids and gelation promoting effect in sol-gel reaction upon heating and drying. Of those, ethylacetoacetate aluminum diisopropylate, aluminum tris(ethylacetoacetate), di(acetylacetonato)titanium complex, and zirconium tris(ethylacetoacetate) are especially preferred.

Description of the counter salt of the above-mentioned metal complex is omitted in this specification. Regarding its kind, the counter salt may be any water-soluble salt capable of keeping the charge of the complex compound neutral. For example, nitrates, hydrohalides, sulfates, phosphates and the like capable of securing stoichiometric neutrality of the complex can be used. The behavior of the metal complex in a silica sol-gel reaction is described in detail in J. Sol-Gel, Sci. and Tec., 16, 209 (1999). For its reaction mechanism, the following scheme may be presumed. Specifically, in a coating liquid, the metal complex has a coordination structure and is therefore stable. In the dehydration condensation reaction that starts in the heating and drying step after coating, the metal complex is presumed to promote crosslinking by utilizing its mechanism like that of an acid catalyst. Anyway, use of the metal complex can satisfy all of the improvement in long-term stability of the coating liquid and the film surface quality, and high hydrophilicity and high durability.

The catalyst (D) is used in an amount in the range of preferably from 0 to 50 mass %, more preferably from 5 to 25 mass %, in terms of a non-volatile component in the hydrophilic composition of the invention. The catalyst (D) may be used alone or in combination of two or more kinds thereof.

### [Other Additives]

In addition, if desired, the composition may also contain, for example, a leveling additive, a mat agent, a wax for controlling the physical properties of the film, and a tackifier for improving the adhesion properties of the film to a substrate within a range not impairing the hydrophilicity of the film.

Specific examples of the tackifier include high-molecular-weight adhesive polymers described in JP-A-2001-49200, pp. 5-6 (e.g., copolymers composed of an ester of (meth)acrylic acid and an alcohol having an alkyl group with from 1 to 20 carbon atoms, an ester of (meth)acrylic acid and an alicyclic alcohol having from 3 to 14 carbon atoms, and an ester of (meth)acrylic acid and an aromatic alcohol having from 6 to 14 carbon atoms); and low-molecular-weight tackifying resins having a polymerizable unsaturated bond.

### [Surfactant]

In the invention, in order to enhance film surface properties of the foregoing hydrophilic composition and the composition for undercoat layer, it is preferred to use a surfactant. Examples of the surfactant include nonionic surfactants, anionic surfactants, cationic surfactants, amphotelic surfactants, and fluorine-containing surfactants.

The nonionic surfactant to be used in the invention is not particularly limited, and conventionally known nonionic surfactants can be used. Examples thereof include polyoxyethylene alkyl ethers, polyoxyethylene alkylphenyl ethers, polyoxyethylene polystyrylphenyl ethers, polyoxyethylene polyoxypropylene alkyl ethers, glycerin fatty acid partial esters, sorbitan fatty acid partial esters, pentaerythritol fatty acid partial esters, propylene glycol mono-fatty acid esters, sucrose fatty acid partial esters, polyoxyethylene sorbitan fatty acid partial esters, polyoxyethylene sorbitol fatty acid partial esters, polyethylene glycol fatty acid esters, polyglycerin fatty acid partial esters, polyoxyethylenated castor oils, polyoxyethylene glycerin fatty acid partial esters, fatty acid diethanolamides, N,N-bis-2-hydroxyalkylamines, polyoxyethylene alkylamines, triethanolamine fatty acid esters, trialkylamine oxides, polyethylene glycol, and a copolymer of polyethylene glycol and polypropylene glycol.

The anionic surfactant to be used in the invention is not particularly limited, and conventionally known anionic surfactants can be used. Examples thereof include fatty acid salts, abietic acid salts, hydroxyalkanesulfonic acid salts, alkanesulfonic acid salts, straight-chain alkylbenzenesulfonic acid salts, branched alkylbenzenesulfonic acid salts, alkylnaphthalenesulfonic acid salts, alkylphenoxypolyoxyethylene propylsulfonic acid salts, polyoxyethylene alkylsulfophenyl ether salts, N-methyl-N-oleyltaurin sodium salt, N-alkylsulfosuccinic acid monoamide disodium salts, petroleum sulfonic acid salts, sulfated beef tallow oil, sulfuric ester salts of a fatty acid alkyl ester, alkylsulfuric ester salts, polyoxyethylene alkyl ether sulfuric ester salts, fatty acid monoglyceride sulfuric ester salts, polyoxyethylene alkylphenyl ether sulfuric ester salts, polyoxyethylene styrylphenyl ether sulfuric ester salts, alkylphosphoric ester salts, polyoxyethylene alkyl ether phosphoric ester salts, polyoxyethylene alkylphenyl ether phosphoric ester salts, a partially saponified product of a styrene/maleic anhydride copolymer, a partially saponified product of an olefin/maleic anhydride copolymer, and naphthalenesulfonic acid salt formalin condensates.

The cationic surfactant to be used in the invention is not particularly limited, and conventionally known cationic surfactants can be used. Examples thereof include alkylamine salts, quaternary ammonium salts, polyoxyethylene alkylamine salts, and polyethylene polyamine derivatives.

The amphoteric surfactant to be used in the invention is not particularly limited, and conventionally known ampholytic surfactants can be used. Examples thereof include carboxybetaines, aminocarboxylic acids, sulfobetaines, aminosulfuric esters, and imidazolines.

Additionally, in the foregoing surfactants, the term “polyoxyethylene” can also be given a different reading as “polyoxyalkylene”, for example, polyoxymethylene, polyoxypropylene, and polyoxybutylene. In the invention, those surfactants can also be used.

As a further preferable surfactant, the fluorine-containing surfactants containing a perfluoroalkyl group in the molecule thereof are exemplified. Examples of such a fluorine-containing surfactant include anionic types such as perfluoroalkylcarboxylic acid salts, perfluoro-alkylsulfonic acid salts, and perfluoroalkylphosphoric esters; amphoteric types such as perfluoroalkylbetaines; cationic types such as perfluoroalkyltrimethylammonium salts; and nonionic types such as perfluoroalkylamine oxides, perfluoroalkyl ethylene oxide adducts, oligomers containing a perfluoroalkyl group and a hydrophilic group, oligomers containing a perfluoroalkyl group and a lipophilic group, oligomers containing a perfluoroalkyl group, a hydrophilic group and a lipophilic group, and urethanes containing a perfluoroalkyl group and a lipophilic group. Also, fluorine-containing surfactants described in JP-A-62-170950, JP-A-62-226143, and JP-A-60-168144 can be preferably exemplified.

The surfactant is preferably used in an amount in the range of from 0.001 to 10 mass %, more preferably from 0.01 to 5 mass % relative to a non-volatile component in the hydrophilic composition of the invention. Also, the surfactants can be used alone or in combination of two or more kinds thereof.

Specific examples of preferred surfactants will be shown below. However, the invention is not limited only to them.

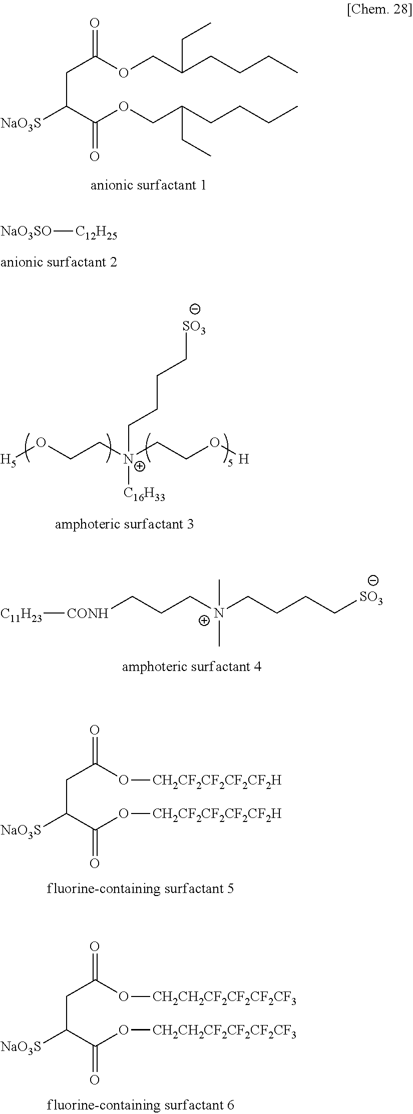

### [Inorganic Fine Particles]

The hydrophilic composition of the invention may contain inorganic fine particles for the purposes of enhancing the cured film strength and hydrophilicity of the hydrophilic film to be formed. Preferred examples of the inorganic fine particles include silica, alumina, magnesium oxide, titanium oxide, magnesium carbonate, calcium alginate, and mixtures thereof.

The inorganic fine particles preferably have an average particle size of from 5 nm to 10 μm, more preferably from 0.5 to 3 μm. When the particle size of the inorganic fine particles falls within the foregoing range, it is possible to form a film with excellent hydrophilicity in which the inorganic fine particles are stably dispersed in the hydrophilic layer and the film strength of the hydrophilic layer is sufficiently kept. The foregoing inorganic fine particles are readily available as a commercial product such as a colloidal silica dispersion.

The inorganic fine particles in accordance with the invention is preferably used in an amount in the range of 20 mass % or less, more preferably 10 mass % or less in terms of a non-volatile component in the hydrophilic composition of the invention. Also, the inorganic fine particles can be used alone or in combination of two or more kinds thereof.

### [Antioxidant]

For the purpose of improving the stability of the hydrophilic member of the invention, an antioxidant can be added to the coating solution for forming the hydrophilic layer. Examples of the antioxidant include those described in EP-A-223739, EP-A-309401, EP-A-309402, EP-A-310551, EP-A-310552, EP-A-459416, DE-A-3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

The addition amount of the antioxidant is properly chosen depending upon the purpose and is preferably from 0.1 to 8 mass % in terms of a non-volatile component.

### (High-Molecular Compound)

Various high-molecular compounds may be added to the coating solution for forming the hydrophilic layer of the hydrophilic member of the present invention in order to control the physical properties of the hydrophilic layer without impairing the hydrophilicity of the layer. Examples of the high-molecular compounds include acrylic polymers, polyvinyl alcohol resins, polyvinyl butyral resins, polyurethane resins, polyamide resins, polyester resins, epoxy resins, phenolic resins, polycarbonate resins, polyvinyl formal resins, shellac, vinyl resins, acrylic resins, rubber resins, waxes, and other natural resins. Two or more of these compounds may be used in combination. Of those, vinyl copolymers available through copolymerization of acrylic monomers are preferred. As a copolymerization composition of a high molecular binder, copolymers having, as a structural unit thereof, a “carboxyl-containing monomer”, “alkyl methacrylate” or “alkyl acrylate” are preferred.

### [Hydrophilic Member]

The hydrophilic member in the invention has a hydrophilic layer formed from the hydrophilic composition on a substrate selected from an acrylic based resin, a polycarbonate based resin, a polyester based resin, stainless steel and aluminum.

The present hydrophilic member has on a substrate a hydrophilic layer formed by coating the substrate with a hydrophilic composition and, now that the hydrophilic composition is the present hydrophilic composition as illustrated above, can become a hydrophilic member which not only has sufficient hydrophilicity, wear resistance, soil resistance and adherence but also can retain excellent lubricity for a long time.

The present hydrophilic member may further have an undercoat layer between the substrate and the hydrophilic layer for the purpose of enhancing adhesion between the substrate and the hydrophilic layer.

Herein, it is preferable that the undercoat layer is formed by coating a composition containing the catalyst (D) as mentioned above, and thereby the adhesion between the substrate and the hydrophilic layer can be more enhanced. In this case, it is preferred similarly to the above that the catalyst (D) be a non-volatile catalyst.

The catalyst (D) is used in an amount ranging preferably from 0 to 50 mass %, more preferably from 1 to 25 mass %, with respect to the non-volatile component in an undercoat layer composition. Additionally, the catalyst (D) may be one kind of compound or a combination of two or more kinds of compounds.

It is also preferable that the undercoat layer is a layer formed by coating with a composition further containing the cross-linking agent (C) as mentioned above, and thereby the adhesion between the substrate and the hydrophilic layer can be enhanced with more certainty.

The cross-linking agent (C) is used in an amount ranging preferably from 5 to 99 mass %, more preferably from 10 to 95 mass %, with respect to the non-volatile component in an undercoat layer composition. Additionally, the cross-linking agent (C) may be used alone or in combination of two or more kinds thereof.

From the viewpoints of wear resistance, acid resistance and alkali resistance, each of the hydrophilic composition and the composition for the undercoat layer can contain a chloride, nitrate, alkoxide or organic complex of zirconium. Examples of a chloride of zirconium include zirconium chloride, zirconium oxychloride (octahydrate) and chlorine-containing zirconium alkoxides of formula Zr(OCₘH₂ₘ₊₁)ₓCl_{y} (wherein m, x, y are integers, and x+y=4), an example of a nitrate of zirconium is zirconium oxynitrate (dehydrate), examples of an alkoxide of zirconium include zirconium ethoxide, zirconium propoxide, zirconium isopropoxide, zirconium butoxide and zirconium t-butoxide, and examples of an organic complex of zirconium are acetylacetone derivatives, specifically including tetrakis(acetylacetonato)zirconium, bis(acetylacetonato)zirconium dibutoxide, bis(acetylacetonato)zirconium dichloride, tetrakis(3,5-heptanedionato)zirconium, tetrakis(2,2,6,6-tetramethyl-3,5-heptanedionato)zirconium and bis(2,2,6,6-tetramethyl-3,5-heptanedionato)zirconium diisopropoxide.

Such zirconium compounds are used in a proportion ranging preferably from 0 to 50 mass %, more preferably from 5 to 25 mass %, as non-volatile ingredients in the present hydrophilic composition and the composition for the undercoat layer.

The hydrophilic member of the invention can be obtained by coating a solution containing such a hydrophilic composition on an adequate substrate and drying the hydrophilic composition. That is, the hydrophilic member of the invention has a hydrophilic film formed by coating the foregoing hydrophilic composition of the invention on a substrate and heating and drying the hydrophilic composition.

In the formation of the hydrophilic film, with respect to the heating and drying condition after coating the solution containing the hydrophilic composition, drying is performed at a temperature in the range of preferably from 10 to 150° C., more preferably from 25 to 100° C. from the viewpoint of efficiently of forming a high-density cross-linked structure. In case when the drying temperature is too low, cross-linking reaction does not proceed sufficiently, leading to low coated film strength whereas, in case when the drying temperature is too high, cracks are liable to be formed in the coated film, leading to partially insufficient antifogging properties. The drying time is preferably from 5 minutes to 1 hour, more preferably from 10 minutes to 30 minutes. In case when the drying time is too short, there can result reduced coated film strength due to insufficient drying. In case when the drying time is prolonged more than is necessary, the substrate can be deteriorated.

The hydrophilic member of the invention can be prepared by a known coating method without particular limitations. Examples of the coating method which can be applied include a spray coating method, a dip coating method, a flow coating method, a spin coating method, a roll coating method, a film applicator method, a screen printing method, a bar coater method, painting with a brush, and painting with a sponge.

The thickness of the hydrophilic layer is preferably from 0.1 μm to 10 μm, more preferably from 0.5 μm to 2 μm. When the film thickness is 0.1 μm or more, sufficient hydrophilicity and durability are obtainable, and therefore, such is preferred whereas, when the film thickness is 10 μm or less, a problem with film properties such as uneven drying is not caused, and therefore, such is preferred.

The center line average roughness, Ra, of the surface of the hydrophilic layer is preferably from 10 nm to 100 nm.

Also, Tg of the hydrophilic layer is preferably from 40° C. to 150° C. from the viewpoint of coated film strength. Also, the modulus of elasticity of the hydrophilic layer is preferably from 1 GPa to 7 GPa.

Additionally, surface properties of the above-described hydrophilic layer can be controlled by adjusting particle size and content of the inorganic particles to be used, surface roughness of the substrate itself, viscosity of the coating solution composition for forming the hydrophilic layer, heating temperature and heating rate of the hydrophilic coated film, and the like, but the invention is not limited only to these factors.

An interlayer may be provided, as needed, between the supporting substrate and the hydrophilic layer for the purpose of improving adhesion or the like.

For example, in the case where the substrate is an aluminum plate, an interlayer may be provided between the aluminum plate and the hydrophilic layer for the purpose of improving, for example, corrosion resistance and adhesion to the substrate. The interlayer is not particularly limited. A hydrophilic layer with a different formulation may be provided, or a known corrosion-resistant layer represented by chromate based layer may be imparted.

### [Surface Free Energy]

The degree of hydrophilicity of the hydrophilic layer surface is in general measured in terms of a water droplet contact angle. However, with respect to a surface with very high hydrophilicity as in the invention, there is a possibility that the water droplet contact angle is not more than 10°, and even not more than 5°. Thus, in mutually comparing the degree of hydrophilicity, there is a limit On the other hand, as a method for evaluating the degree of hydrophilicity on a solid surface in detail, there is a method of measuring surface free energy. There have been proposed various methods. In the invention, however, the surface free energy was measured by employing the Zisman plot method as one example. Specifically, the Zisman plot method is a measurement method in which, by utilizing the properties that, in an aqueous solution of an inorganic electrolyte such as magnesium chloride, its surface tension becomes large with an increase of the concentration thereof, a contact angle is measured in air under a room temperature condition using the aqueous solution; a surface tension of the aqueous solution is taken on the abscissa, whereas a value obtained by reducing the contact angle into cos θ is taken on the ordinate; points of the aqueous solution of various concentrations are plotted to obtain a linear relationship; and the surface tension at cos θ=1, namely at a contact angle of 0° is defined as surface free energy of the solid. The surface tension of water is 72 mN/m, and it may be said that, the larger the value of surface free energy, the higher the hydrophilicity is.

The hydrophilic layer in which the surface free energy as measured in such a method is in the range of from 70 mN/m to 95 mN/m, preferably from 72 mN/m to 93 mN/m, more preferably from 75 mN/m to 90 mN/m, is excellent in hydrophilicity and exhibits a satisfactory performance.

### [Prepared Solution of Hydrophilic Composition]

Preparation of the hydrophilic composition can be carried out by dissolving a specific hydrophilic polymer (A) and/or a specific hydrophilic polymer (B), a cross-linking agent (C) and, if required, a catalyst (D) and a specific alkoxide (F) in a solvent such as ethanol, and then stirring those ingredients into the solvent. The reaction temperature is in a range of room temperature to 80° C., and the reaction time, or the duration of stirring, preferably ranges from 1 hour to 72 hours. By such stirring, hydrolysis and polycondensation between both the ingredients are made to proceed, and an organic-inorganic hybrid sol liquid can be obtained.

As to the solvent used in preparing the hydrophilic composition, there is no particular restriction so long as the ingredients can be dissolved or dispersed homogeneously into the solvent, but it is advantageous to use an aqueous solvent, such as methanol, ethanol or water.

As mentioned above, preparation of an organic-inorganic hybrid sol liquid (hydrophilic composition) for forming a hydrophilic film from the present hydrophilic composition is carried out by utilizing a sol-gel method. Sol-gel methods are described in detail in books such as Sumio Sakuhana, Sol-Gel-Ho no Kagaku, published by Agune Shofu Sha (1988); and Ken Hirashima, Saishin Sol-Gel-Ho niyoru Kinosei Hakumaku Sakusei Gijutsu, published by General Technology Center (1992). In the invention, the methods described in these books can be applied to preparation of the hydrophilic composition.

### [Prepared Solution of Composition for Undercoat Layer]

A composition for an undercoat layer can be prepared in a manner similar to the hydrophilic composition.

The present hydrophilic member can be obtained by coating an appropriate substrate with a solution containing such a composition for an undercoat layer for use in the invention and a solution containing the present hydrophilic composition, and then by drying them. More specifically, the present hydrophilic member can be obtained by forming an undercoat layer on a substrate through the application and heat-drying of an undercoat layer composition, and then by forming an overcoat layer on the undercoat layer through the application and heat-drying of the present hydrophilic composition.

As to the heat-drying conditions, from the viewpoint of forming a high-density cross-linked structure with efficiency, it is preferred that the heat-drying be carried out at temperatures ranging from 50° C. to 200° C. for a time of the order of 2 minutes to 1 hour, and it is more preferred that the compositions be dried at temperatures ranging from 80° C. to 160° C. for a time of from 5 to 30 minutes. As a heating device used herein, well-known devices, including a dryer having a temperature-regulating function, are suitable.

Additionally, in the case of making the present hydrophilic member by coating an overcoat layer and an undercoat layer on a substrate, catalysts can be mixed in compositions for forming the layers immediately before the compositions are applied to the substrate. To be more specific, it is appropriate that the compositions be applied within one hour of the instant following the catalyst mixing. When the catalyst-mixed undercoat layer composition and the catalyst-mixed hydrophilic composition are applied after they are allowed to stand for a long time, they suffer viscosity increases, and thereby defects including unevenness of coatings may be caused. Although it is also preferred that the other ingredients be mixed together immediately before applying them, it doesn't matter if they are stored for a long time after mixing.

### [Substrate]

The substrate for use in the invention is not particularly limited, and any of glass, plastics, metals, ceramics, wood, stones, cement, concrete, fibers, fabrics, paper, leathers, tiles, rubbers, latexes, and their combinations and laminates can favorably be used. Particularly preferred are flexible substrates such as plastic substrates and metal substrates. Use of such flexible substrates allows to transform articles, which serves to increase degree of freedom with respect to mounting work and mounting site and to enhance durability.

The plastic substrate to be used in the invention is not particularly limited. For example, as a substrate to be used for optical members, an appropriate one is selected in consideration of the optical properties thereof such as the transparency, the refractivity, and the dispersibility thereof and, therefore, the substrate of the type is selected in consideration of various properties thereof, for example, the physical properties such as strength, e.g., impact resistance and flexibility thereof, and also the heat resistance, the weather resistance, and the durability thereof, depending upon its use. As the plastic substrate, there can be illustrated films or sheets of polyester, polyethylene, polypropylene, cellophane, triacetyl cellulose, diacetyl cellulose, acetyl cellulose butyrate, polyvinyl chloride, polyvinylidene chloride, polyvinyl alcohol, polyethylene-vinyl alcohol, polystyrene, polycarbonate, polymethylpentene, polysulfone, polyether ketone, acrylic resin, nylon, fluorine-containing resin, polyimide, polyetherimide, and polyether sulfone. Among these, polyester film such as polyethylene terephthalate, polyetylene naphthalate is especially preferred. Depending on their use, these may be used alone or as combined in the form of their mixtures, copolymers or laminates. The thickness of the plastic substrate varies depending upon kind of the layer to be laminated thereon. For example, in a part having many curved profiles, thinner substrates are preferred, and substrates having a thickness of from about 6 to about 50 μm are used. Also, in a flat part, or in a part that must have high strength, substrates having a thickness of from 50 to 400 μm are used.

For the purpose of increasing the adhesion between the substrate and the undercoat layer, if desired, one or both surfaces of the substrate may be treated for imparting hydrophilicity to the surface through oxidation or surface roughening. As the oxidation treatment, there are illustrated, for example, corona discharge treatment, glow discharge treatment, chromic acid treatment (wet treatment), flame treatment, hot air treatment, and ozone/UV irradiation treatment. As to the surface-roughening treatment, mechanical surface-roughening treatment may be conducted by sand blasting or brushing.

The plastic substrate for use herein may comprise an inorganic compound layer such as that mentioned hereinafter for glass sheets, formed on a plastic sheet. In this case, the inorganic compound layer may serve as an antireflection layer. The inorganic compound layer may be formed on a plastic sheet in the same manner as that mentioned hereinabove for inorganic substrates.

In the case where an inorganic compound layer is formed on a transparent plastic substrate, a hard coat layer may be formed between the two layers. The hard coat layer may improve the surface hardness of the substrate having it, and may smooth the substrate surface, and, therefore, the adhesion between the transparent plastic substrate and the inorganic compound layer may be improved, the scratch resistance of the substrate may be improved, and the inorganic compound layer may be prevented from being cracked when the substrate is bent. Use of the substrate of the type improves the mechanical strength of the hydrophilic member. Materials for forming the hard coat layer are not particularly limited, and any material having transparency and suitable strength, and mechanical strength may be used. For example, a resin curable through irradiation with ionizing radiations or UV rays, or a thermosetting resin may be used and, in particular, UV-curable acrylic resins, organo-silicon resins, and thermosetting polysiloxane resins are preferred. More preferably, the refractive index of the resin is on the same level as or is near to the refractive index of the transparent plastic substrate.

Methods for forming the hard coat layer are not particularly limited, and any method that can permit uniform coating may be employed. The thickness of the hard coat layer may be 3 μm or more for its sufficient strength, but is preferably within a range of from 5 to 7 μm in view of the transparency, the coating accuracy, and the handlability thereof. Further, inorganic or organic particles having an average particle size of from 0.01 to 3 μm may be mixed and dispersed in the hard coat layer for light diffusion treatment of the layer generally referred to as antiglare treatment. The material of the particles is not particularly limited and may be any transparent one, but is preferably one having a low refractive index. Particularly preferred are silicon oxide and magnesium fluoride in view of their stability and heat resistance. The light diffusion treatment may also be attained by roughening the surface of the hard coat layer. The adherence between the substrate and the undercoat layer can be improved by setting these inorganic compound layer and hard coat layer between the substrate and the undercoat layer.

As the metal thin sheet, an aluminum sheet is particularly preferred.

The aluminum sheet is a pure aluminum sheet, an alloy sheet mainly composed of aluminum and containing trace amounts of foreign elements, or a sheet wherein a plastic film is laminated on a thin film of aluminum or aluminum alloy. The foreign elements contained in the aluminum alloys include silicon, iron, manganese, copper, magnesium, chromium, zinc, bismuth, nickel, and titanium. The amount of the foreign elements contained in the alloys is 10% by weight or less than that. Of these, a pure aluminum sheet is preferred in the invention. However, it is difficult to produce pure aluminum in terms of refining technology, so that aluminum containing the foreign elements in trace amounts is also allowed. The aluminum sheets are not particularly limited as to their composition, and aluminum sheets made of previously known and used materials can be appropriately utilized.

The thickness of the substrate is preferably from 0.05 to 0.6 mm, more preferably from 0.08 to 0.2 mm.

Prior to use, the aluminum sheet is preferably subjected to a surface treatment such as a surface-roughening treatment or an anode oxidation treatment. By the surface treatment, the improvement of the hydrophilicity of the substrate and the ensuring of the adherence between the undercoat layer and the substrate become easier. Prior to the surface-roughening treatment of the aluminum sheet, degreasing treatment may be conducted, as needed, with a surfactant, an organic solvent or with an alkaline aqueous solution for removing rolling oil remaining on the surface of the sheet. The methods for treating the aluminum substrate may be conducted in a known manner.

As the substrate to be used in the invention, a substrate having been subjected to the surface treatment as described above and having an anodic oxide film may be used as such but, in order to more improve adhesion to the upper layer, the substrate may be subjected to another treatment as need, for example, the treatment for expanding or sealing the micropores in the anodic oxide film described in JP-A-2001-253181 and JP-A-2001-322365 or a surface hydrophilizing treatment of immersing it in an aqueous solution containing a hydrophilic compound. The expanding and sealing treatments are not limited to the methods described above, and any one of conventionally known methods may be used.

For example, as the micropore sealing treatment, treatment with fluorozirconic acid alone, treatment with sodium fluoride, and treatment with lithium chloride-containing steam may be employable as well as treatment with steam.

### <Micropore Sealing Treatment>

The micropore sealing treatment to be used in the invention is not particularly limited, and any of conventionally known treatments may be used. Among them, micropore sealing treatment in an aqueous solution containing an inorganic fluorine compound, micropore sealing treatment with water vapor, and micropore sealing treatment with hot water are preferred. The treatments are respectively described below.

### <Micropore Sealing Treatment in an Aqueous Solution Containing an Inorganic Fluorine Compound>

The inorganic fluorine compound to be used in micropore sealing treatment in an aqueous solution containing an inorganic fluorine compound is preferably a metal fluoride.

Specifically, there are illustrated, for example, sodium fluoride, potassium fluoride, calcium fluoride, magnesium fluoride, sodium fluorozirconate, potassium fluorozirconate, sodium fluorotitanate, potassium fluorotitanate, ammonium fluorozirconate, ammonium fluorotitanate, fluorozirconic acid, fluorotitanic acid, hexafluorosilicic acid, nickel fluoride, iron fluoride, fluorophosphoric acid, and ammonium fluorophosphate. Of these, sodium fluorozirconate, sodium fluorotitanate, fluorozirconic acid, and fluorotitanic acid are preferred.

The concentration of the inorganic fluorine compound in the aqueous solution is 0.01 mass % or more, more preferably 0.05 mass % or more, to sufficiently seal the micropores on the anodic oxide film, and preferably 1 mass % or less, more preferably 0.5 mass % or less, from the viewpoint of stain resistance.

Preferably, the aqueous solution containing an inorganic fluorine compound further contains a phosphate compound. Preferred examples of the phosphate compound include metal phosphates such as alkali metal phosphates and alkaline metal phosphates.

Specific examples thereof include zinc phosphate, aluminum phosphate, ammonium phosphate, diammonium hydrogen phosphate, ammonium dihydrogen phosphate, monoammonium phosphate, monopotassium phosphate, monosodium phosphate, potassium dihydrogen phosphate, dipotassium hydrogen phosphate, calcium phosphate, ammonium sodium hydrogen phosphate, magnesium hydrogen phosphate, magnesium phosphate, ferrous phosphate, ferric phosphate, sodium dihydrogen phosphate, sodium phosphate, disodium hydrogen phosphate, lead phosphate, diammonium phosphate, calcium dihydrogen phosphate, lithium phosphate, phosphotungstic acid, ammonium phosphotungstate, sodium phosphotungstate, ammonium phosphomolybdate, sodium phosphomolybdate, sodium phosphite, sodium tripolyphosphate, and sodium pyrophosphate. Of these, sodium dihydrogen phosphate, disodium hydrogen phosphate, potassium dihydrogen phosphate, and dipotassium hydrogen phosphate are preferred.

Combination of the inorganic fluorine compound and the phosphate compound is not particularly limited, but it is preferred that the aqueous solution contains at least sodium fluorozirconate as the inorganic fluorine compound and at least sodium dihydrogen phosphate as the phosphate compound.

The concentration of the phosphate compound in the aqueous solution is preferably 0.01 mass % or more, more preferably 0.1 mass % or more, from the viewpoint of stain resistance, and is preferably 20 mass % or less, more preferably 5 mass % or less, from the viewpoint of solubility.

The proportion between the compounds in the aqueous solution is not particularly limited, but the weight ratio between the inorganic fluorine compound and the phosphate compound is preferably from 1/200 to 10/1, more preferably from 1/30 to 2/1.

Also, the temperature of the aqueous solution is preferably 20° C. or more, more preferably 40° C. or more, and is preferably 100° C. or less, more preferably 80° C. or less.

The pH of the aqueous solution is preferably 1 or more, more preferably 2 or more, and is preferably 11 or less, more preferably 5 or less.

The method for the micropore sealing treatment in an aqueous solution containing an inorganic fluorine compound is not particularly limited, and examples thereof include an immersion method and a spray method. Operations in these methods may be performed once or more than once individually, or those methods may be used in combination.

Among the methods, the immersion method is preferred. In the case where the immersion method is used for the treatment, the treatment period is preferably 1 second or more, more preferably 3 seconds or more, and is preferably 100 seconds or less, more preferably 20 seconds or less.

### <Micropore Sealing Treatment in Steam>

The micropore sealing treatment in steam can be performed, for example, by bringing steam under elevated or normal pressure into contact with the anodic oxide film continuously or non-continuously.

The temperature of the steam is preferably 80° C. or higher, more preferably 95° C. or higher, and is preferably 105° C. or lower.

The pressure of the steam is preferably in the range of (atmospheric pressure−50 mmAq) to (atmospheric pressure+300 mmAq), or (1.00×10⁵ to 1.043×10⁵ Pa).

The contact time of the steam is preferably 1 second or more, more preferably 3 seconds or more, and is preferably 100 seconds or less, more preferably 20 seconds or less.

### <Micropore Sealing Treatment in Hot Water>

The micropore sealing treatment in steam is performed, for example, by immersing an aluminum sheet having formed thereon an anodic oxide film in hot water.

The hot water may contain an inorganic salt (e.g., phosphate salt) or an organic salt.

The temperature of the hot water is preferably 80° C. or higher, more preferably 95° C. or higher, and is preferably 100° C. or lower.

The period of immersion in hot water is preferably 1 second or more, more preferably 3 seconds or more, and is preferably 100 seconds or less, more preferably 20 seconds or less.

### <Hydrophilizing Treatment>

As the hydrophilizing treatment, there is illustrated the alkali metal silicate methods described in U.S. Pat. Nos. 2,714,066, 3,181,461, 3,280,734, and 3,902,734. In this treatment, the support is immersed or electrolyzed, for example, in an aqueous solution of sodium silicate or the like. Also included are the method of treating the support with potassium fluorozirconate described in JP-B-36-22063 and the method of treating it with polyvinylphosphonic acid described in U.S. Pat. Nos. 3,276,868, 4,153,461, and 4,689,272.

The support preferably has an average center-line roughness of from 0.10 to 1.2 μm. In this range, it is possible to obtain desirable adhesion to the undercoat layer and good staining resistance.

As a glass plate to be used in the invention, there can be illustrated glass plates with inorganic compound layers formed from metallic oxides such as silicon oxide, aluminum oxide, magnesium oxide, titanium oxide, tin oxide, zirconium oxide, sodium oxide, antimony oxide, indium oxide, bismuth oxide, yttrium oxide, cerium oxide, zinc oxide, and ITO (Indium Tin Oxide); and metal halides such as magnesium fluoride, calcium fluoride, lanthanum fluoride, cerium fluoride, lithium fluoride, and thorium fluoride. Also, float sheet glass, figured sheet glass, ground sheet glass, wire glass, crosswire glass, tempered glass, laminated glass, multilayered glass, vacuum glass, security glass and high-heat insulating Low-E multi-layered glass can be used depending upon the purpose.

Though the undercoat layer and the overcoat layer can be provided by coating on a raw sheet glass as it is, for the purpose of enhancing the adhesion between the undercoat layer and the overcoat layer, one surface or both surfaces of the sheet glass can be subjected to a surface hydrophilization treatment such as an oxidation method and a roughing method as the need arises. Examples of the foregoing oxidation method include a corona discharge treatment, a glow discharge treatment, a chromic acid treatment (wet type), a flame treatment, a hot blast treatment, and an ozone or ultraviolet ray irradiation treatment. As the roughing method, mechanical roughing by sand blast, brush polishing, etc. can be applied.

Such inorganic compound layers each can be configured to have a single-layer or multilayer structure. Depending on the thickness, each inorganic compound layer allows retention of transmittance to light in some instances, or allows action as an antireflection layer in other instances. To the formation of inorganic compound layers are applicable known methods including coating methods such as a dip coating method, a spin coating method, a flow coating method, a spray coating method, a roll coating method, and a gravure coating method; and vapor-phase methods, notably a physical vapor deposition (PVD) method and a chemical vapor deposition (CVD) method, such as a vacuum evaporation method, a reactive evaporation method, an ion-beam assist method, a sputtering method, and an ion plating method.

Examples of the hydrophilic resin include polyvinyl alcohol (PVA), cellulose resins [e.g., methyl cellulose (MC), hydroxyethyl cellulose (HEC), and carboxymethyl cellulose (CMC)], chitins, chitosans, starch, ether bond-having resins [e.g., polyethylene oxide (PEO), polyethylene glycol (PEG), and polyvinyl ether (PVE)], carbamoyl-containing resins [e.g., polyacrylamide (PAAM) and polyvinylpyrrolidone (PVP)]. They also include carboxyl-containing polyacrylates, maleic acid resins, alginates, and gelatins.

Of the above, least one selected from polyvinyl alcohol resins, cellulose resins, ether-bond-having resins, carbamoyl-containing resins, carboxyl-containing resins and gelatins is preferred, with polyvinyl alcohol (PVA) resins and gelatins being especially preferred.

Examples of the water dispersible latexes include acrylic latexes, polyester latexes, NBR resins, polyurethane latexes, polyvinyl acetate latexes, SBR resins, and polyamide latexes. Of these, acrylic latexes are preferred.

The hydrophilic resins or the water dispersible latexes may be used either singly or in combination of two or more thereof. Alternatively, the hydrophilic resin and the water dispersible latex may be used in combination.

A crosslinking agent capable of crosslinking the hydrophilic resin or the water dispersible latex may be used.

As the crosslinking agent usable in the present invention, known crosslinking agents capable of forming a crosslink by heat can be used. Typical thermal crosslinking agents are described in “Handbook of Crosslinking Agents” by Shinzo Yamashita and Tohsuke Kaneko, published by Taisei-sha (1981). No particular limitation is imposed on the crosslinking agent usable in the present invention insofar as it has at least two functional groups and is capable of effectively crosslinking the hydrophilic resin or the water dispersible latex. Specific examples of the thermal crosslinking agent include polycarboxylic acids such as polyacrylic acid; amine compounds such as polyethyleneimine; polyepoxy compounds such as ethylene or propylene glycol diglycidyl ether, tetraethylene glycol diglycidyl ether, nonaethylene glycol diglycidyl ether, polyethylene or polypropylene glycol glycidyl ether, neopentyl glycol diglycidyl ether 1,6-bexanediol diglycidyl ether, trimethylolpropane triglycidyl ether, and sorbitol polyglycidyl ether; polyaldehyde compounds such as glyoxal and terephthalaldehyde; polyisocyanate compounds such as tolylene diisocyanate, hexamethylene diisocyanate, diphenylmethane isocyanate, xylylene diisocyanate, polymethylene polyphenyl isocyanate, cyclohexyl diisocyanate, cyclohexanephenylene diisocyanate, naphthalene-1,5-diisocyanate, isopropylbenzene-2,4-diisocyanate, polypropylene glycol/tolylene diisocyanate adducts; block polyisocyanate compounds; silane coupling agents such as tetraalkoxysilanes; metal crosslinking agents such as aluminum, copper or iron(III) acetylacetonate; and polymethylol compounds such as trimethylolmelamine and pentaerythritol. Of these thermal crosslinking agents, water-soluble ones are preferred from the standpoint of easy preparation of coating solutions and prevention of the deterioration of hydrophilicity of the resulting hydrophilic layer.

The total amount of the hydrophilic resin and/or the water-dispersible latex in the undercoat layer is preferably from 0.01 to 20 g/m², more preferably from 0.1 to 10 g/m².

### [Layer Constitution Upon Using the Hydrophilic Member]

When the hydrophilic member of the present invention is used with expecting an expression of antifouling property and/or antifogging property effect, another layer may be added thereto as needed, depending on its object, shape and service site. The layer constitution to be added as needed will hereinafter be described.

### 1) Adhesive Layer:

When the hydrophilic member of the present invention is used after attached to another substrate, an adhesive which is a pressure-sensitive adhesive is preferably used as an adhesive layer on the backside of the substrate. As the adhesive, those ordinarily used for adhesive sheets such as rubber adhesive, acrylic adhesive, silicone adhesive, vinyl ether adhesive and styrene adhesive can be used.

When an optically transparent adhesive is required, an adhesive for optical use is selected. When a colored, semitransparent or matted pattern is needed, a pattern may be drawn on the substrate, or a dye or organic or inorganic particles may be added to adhesives to produce such an effect.

When a tackifier is needed, one or more tackifying resins such as rosin resins, terpene resins, petroleum resins, and styrene resins, and hydrogenated products thereof may be used either singly or as a mixture.

The adhesive to be used in the present invention has an adhesive powder as strong as 200 g/25 mm or greater, preferably 300 g/25 mm or greater, more preferably 400 g/25 mm or greater. The adhesive power as referred to herein is determined according to the 180° peel test in accordance with JISZ0237.

### 2) Release Layer

When the hydrophilic member of the present invention has the above adhesive layer, it may further have a release layer. The release layer preferably contains a release agent for having release properties. Examples of the release agent include silicone release agents made of polyorganosiloxane, fluorine-containing compounds, long chain alkyl-modified polyvinyl alcohols, and long chain alkyl-modified polyethyleneimines. Additional examples include, as well as various release agents such as hot-melt release agents and monomer release agents capable of curing releasable monomers through radical polymerization, cationic polymerization, polycondensation, or the like, copolymer resins such as acrylic-silicone copolymer resins, acrylic-fluorine copolymer resins, and urethane-silicone-fluorine copolymer resins and resin blends such as silicone resin/acrylic resin blend, fluororesin/acrylic resin blend. Alternatively, the release layer may be a hard-coat release layer available by curing a curable composition containing a fluorine atom and/or a silicon atom and a compound containing an active-energy-ray polymerizable-group.

### 3) Other Layers

A protective layer may be formed on the overcoat layer (hydrophilic layer). The protective layer has a function of preventing the hydrophilic surface from being scratched during handling, transportation or storage or a function of preventing deterioration of the hydrophilicity of the layer which will otherwise occur due to adhesion of a dirt thereto. As the protective layer, the hydrophilic polymer layer used for the above release layer is usable. The protective layer may be peeled off after the hydrophilic member has been adhered to a suitable substrate.

### [Form of Structure]

The structure containing the hydrophilic layer of the present invention may be provided in the form of a sheet, a roll or a ribbon, or may be provided after cut for the purpose of attaching it to a suitable substrate.

When the hydrophilic member wherein the hydrophilic layer of the invention is applied is used for windowpanes (used for windowpanes or adhered thereto), its transparency is important for securing view through it. The hydrophilic layer of the invention has excellent transparency, and even though it is thick, its transparency is not impaired. Accordingly, the hydrophilic layer of the present invention may satisfy both transparency and durability.

The thickness of the hydrophilic layer of the present invention is preferably from 0.01 to 100 μm, more preferably from 0.05 to 50 μm, most preferably from 0.1 to 20 μm. The thicknesses of 0.01 μm or greater are preferred because they provide sufficient hydrophilicity and durability. The thicknesses not greater than 100 μm are also preferred because the problems in film forming property such as cracking do not occur.

The above-described thickness can be attained by adjusting the dry coated amount of the hydrophilic layer of the invention to preferably from 0.01 g/m² to 100 g/m², more preferably from 0.02 g/m² to 80 g/m², particularly preferably from 0.05 g/m² to 50 g/m².

Also, the thickness of the undercoat layer is preferably from 0.01 μm to 100 μm, more preferably from 0.02 μm to 80 μm, still more preferably from 0.05 μm to 50 μm.

The above-described thickness can be attained by adjusting the dry coated amount of the undercoat layer composition of the invention to preferably from 0.01 g/m² to 100 g/m², more preferably from 0.02 g/m² to 80 g/m², particularly preferably from 0.05 g/m² to 50 g/m².

Transparency is evaluated by measuring light transmission of a visible light range (400 nm to 800 nm) with a spectrophotometer. The light transmission is preferably from 100% to 70%, more preferably from 95% to 75%, most preferably from 95% to 80% of range. Within this range, the hydrophilic member wherein the hydrophilic layer is applied can be applied to a various application without interrupting a filed of view.

The hydrophilic member of the present invention, as described above, can be obtained by applying the composition for the undercoat layer and the hydrophilic composition to a proper substrate, followed by heating and drying and to form the surface hydrophilic layer.

As a coating method for the composition for the undercoat layer and the hydrophilic composition, known application methods can be adopted, and for example, a spray coating method, a dip coating method, a flow coating method, a spin coating method, a roll coating method, a film applicator method, a screen printing method, a bar coater method, a brush coating method, or a sponge coating method can be used.

The hydrophilic member of the present invention can be used for, when an antifogging effect is expected, transparent materials, for example, transparent glass substrates or transparent plastic substrates, lenses, prisms, mirrors, and the like.

As glass, any of soda glass, lead glass, borosilicate glass, and the like may be used. Depending on their use, float sheet glass, figured glass, frosted sheet glass, meshed glass, wired glass, reinforced glass, laminate glass, pair glass, vacuum glass, security glass, and high thermal-insulation low-E pair glass can be used.

Members having an antifogging effect can be applied to mirrors such as rearview mirrors for vehicles, mirrors in bathrooms, mirrors in washrooms, mirrors for dental use, and road mirrors; lenses such as eyeglass lenses, optical lenses, camera lenses, endoscope lenses, lenses for illumination, lenses for semiconductors, and lenses for duplicators; prisms; windowpanes for buildings or control towers; glass for other building materials; windowpanes for various vehicles, such as cars, railroad carriages, airplanes, ships, midget submarines, snowmobiles, ropeway gondolas, and gondolas in amusement parks; windshield glass for various vehicles, such as cars, railroad carriages, airplanes, ships, midget submarines, snowmobiles, motorcycles, ropeway gondolas, and gondolas in amusement parks; protector goggles, sports goggles, protector mask shields, sports mask shields, helmet shields, and glass cases for frozen food display; cover glass for metering instruments; and films to be attached to the surface of the above articles. The most preferred application is glass for cars and building materials.

When the surface hydrophilic member of the invention is expected to exhibit an antifouling effect, any of metals, ceramics, woods, stones, cements, concretes, fibers, textiles, and papers, and combinations and laminations thereof as well as glasses and plastics can be used as the substrate.

Examples of applications to which the member having an antifouling effect can be applied include building materials, building exterior materials such as siding walls and roofs, building interiors, window frames, windowpanes, structural members, exteriors and paints of vehicles such as cars, railroad carriages, airplanes, ships, bicycles, and motorcycles, exteriors of machinery and articles, dustproof covers and paints, traffic signs, various display devices, advertising towers, road noise barriers, railroad noise barriers, bridges, exteriors and paints of guardrails, interiors and paints of tunnels, insulators, solar cell covers, heat collector covers for solar water heaters, PVC greenhouses, covers for vehicle lights, housing equipment, toilets, bathtubs, washstands, lighting instruments, lighting instrument covers, kitchen utensils, dishes, dish washers, dish driers, sinks, cooking ovens, kitchen hoods, ventilation fans, and films to be attached to the surface of the above articles.

They further include signboards, traffic signs, noise barriers, PVC greenhouses, insulators, covers for vehicles, tent materials, reflectors, sliding doors, screen doors, solar cell covers, heat collector covers for solar water heaters, street lamps, pavements, outdoor lightings, stone materials/tiles for artificial waterfalls/artificial fountains, bridges, greenhouses, external wall materials, sealers between walls or glasses, guardrails, balconies, vending machines, outdoor units of air conditioners, outdoor benches, various display devices, shutters, tollbooths, rate boxes, roof gutters, protecting covers for vehicle lamp, dustproof covers and paints, paints of machinery and articles, exteriors and paints of advertising towers, structural members, housing equipment, toilets, bathtubs, washstands, lighting instruments, kitchen utensils, dishes, dish driers, sinks, cooking ovens, kitchen hoods, ventilation fans, window rails, window frames, tunnel interior walls, tunnel interior lightings, window sashes, heat radiation fins for heat exchangers, pavements, mirrors for bathrooms and washrooms, ceilings for PVC greenhouses, washing stands, car bodies, and films and emblems which can be attached to these articles.

The member is also applicable to roof materials, antenna and power transmission lines in snowy districts. When it is applied to them, it may exhibit an excellent snow-accretion preventing effect.

Also, in the case where the surface-hydrophilic member of the invention is expected to show quick water-drying properties, examples of the substrate include metal, ceramic, wood, stone, cement, concrete, fiber, fabric, paper and combinations or laminates of these materials can preferably be utilized as a substrate beside the glasses and plastics. Examples of uses to which the member showing quick water-drying properties is applicable include building materials; exteriors of buildings such as exterior walls and roofs; interiors of buildings, window frames, window panes, and structural members; exteriors and coatings of vehicles such as automobiles, rail cars, aircraft, boats and ships, bicycles, and motorbikes; exteriors, dust-resistant covers and coatings of mechanical devices and articles; exteriors and coatings of traffic signs, various display devices, advertising towers, road sound abatement shields, railroad soundproof walls, bridges, and guardrails; interiors and coatings of tunnels; insulators, solar cell covers, heat collecting covers of solar water heaters, vinyl houses, panel light covers of cars, home accommodations, toilets, bathtubs, washstands, lighting fixtures, illumination covers, kitchen utensils, dishes, dish washers, dish driers, sinks, kitchen ranges, kitchen hoods, ventilating fans, and films for sticking to the surface of the above-described articles.

Also included are signboards, traffic signs, soundproof walls, vinyl houses, insulators, covers for vehicles, tent materials, anti-reflection plates, shutters, screen doors, solar cell covers, covers for heat collectors of solar water heaters, streetlights, paved roads, outdoor illumination, stones for artificial fall and artificial fountain, tiles, bridges, greenhouses, outside wall members, sealers between walls or glasses, guardrails, verandas, vending machines, outdoor machines for air conditioners, outdoor benches, various display devices, shutters, tollgates, fee boxes, gutters for roofs, covers for protecting vehicle lamps, dust-resistant covers and coatings, coatings of mechanical apparatuses and articles, exteriors and coatings of advertising towers, structural members, home accommodations, toilets, bathtubs, washstands, lighting fixtures, kitchen utensils, dishes, dish driers, sinks, kitchen ranges, kitchen hoods, ventilating fans, window rails, window frames, inside walls of tunnels, illumination inside tunnels, window sashes, fin stocks of heat exchangers, road mirrors, mirrors for use in bathrooms, washstand mirrors, ceilings for vinyl houses, washing and dressing tables, automobile bodies, and films for sticking to the surface of the above-described articles. Also, in the case where a drying step is provided in the process of producing products for use in these applications, it is expected that drying period can be shortened, which serves to improve productivity.

Of the uses described above, application of the hydrophilic member in accordance with the invention to fin stocks is preferred, particularly preferably to a fin stock made from aluminum. That is, the fin stock of the invention is a fin stock comprising a fin body (preferably an aluminum fin body) and a hydrophilic layer provided on at least part of the surface of the fin body, with the hydrophilic layer being formed by coating the hydrophilic composition in accordance with the invention.

An aluminum fin stock used in a heat exchanger for a room air conditioner or a car air conditioner (aluminum-made fin body itself) causes degradation in cooling capabilities during the cooling operation, because aggregated water produced during the cooling grows into water drops and stays between fins to result in formation of water bridges. In addition, dust gets deposited between fins, and thereby degradation in cooling capabilities is also caused. With these problems in view, fin stocks having excellent hydrophilic and antifouling properties and long persistence of these properties are obtained by applying the hydrophilic members of the invention to fin stocks wherein the composition of the invention for forming a hydrophilic film is coated on a fin body.

It is preferred that the fin stocks in accordance with the invention have water contact angles of 40° or below after they are subjected to 5 cycles of treatment including exposure to palmitic acid gas for 1 hour, washing with water for 30 minutes, and drying for 30 minutes.

Examples of the aluminum to be used for the fin body of the fin stock include that having a degreased surface and aluminum plates subjected to chemical conversion treatment if necessary. The fin bodies made of aluminum and having a surface subjected to chemical conversion treatment are preferred from the standpoint of adhesion properties and corrosion resistance of a hydrophilized film. An example of the chemical conversion treatment is chromate treatment. Typical examples of chromate treatment include alkali salt-chromate methods (such as B.V. method, M.B.V. method, E.W. method, Alrock method, and Pylumin method), a chromic acid method, a chromate method and a phosphoric acid-chromic acid method, and non-washing coat-type treatment with a composition composed mainly of chromium chromate.

Examples of a thin aluminum plate usable for the fin body of the fin stock of a heat exchanger include pure aluminum plates compliant with JIS, such as 1100, 1050, 1200 and 1N30, Al—Cu alloy plates compliant with JIS, such as 2017 and 2014, Al—Mn alloy plates compliant with JIS, such as 3003 and 3004, Al—Mg alloy plates compliant with JIS, such as 5052 and 5083, and Al—Mg—Si alloy plates compliant with JIS, such as 6061. And these thin plates may have either sheeted or coiled shape.

Also, fin stocks in accordance with the invention are preferably used in heat exchangers. The heat exchangers using fin stocks in accordance with the invention can prevent water drops and dust from depositing between fins because the fin stocks have excellent hydrophilic and antifouling properties and long persistence of these properties. As the heat exchangers, there are illustrated heat exchangers for use in a room cooler or room-air conditioner, an oil cooler for construction equipment, a car radiator, a capacitor, and so on.

Also, it is preferred that the heat exchangers with fin stocks in accordance with the invention be used in air conditioners. The fin stocks in accordance with the invention have excellent hydrophilic and antifouling properties and long persistence of these properties, and hence they can provide air conditioners less suffering the problem of degradation in cooling capabilities as described hereinbefore. These air conditioners may be any of room-air conditioners, packaged air conditioners, and car air-conditioners.

In addition, known techniques (as disclosed in JP-A-2002-106882 and JP-A-2002-156135) can be applied to the heat exchangers and air conditioners according to the invention, and the invention is not particularly limited by them.

### EXAMPLES

The invention is hereafter illustrated in detail by reference to the following examples, but these examples should not be construed as limiting the scope of the invention.

### Example 1

Float plate glass (thickness: 2 mm), the most common transparent plate glass, was prepared. The surface of the plate glass was rendered hydrophilic by 10-minute UV/O₃ treatment, and then spin-coated with a first layer coating solution (1) having the following composition, and further dried at 100° C. for 10 minutes by means of an oven, whereby the first layer having a dry coated amount of 1.0 g/m² was formed. After sufficient cooling at room temperature, the first layer-coated surface was coated with a hydrophilic layer coating solution (1) for forming a second layer by means of a bar coater, and dried at 150° C. for 30 minutes by means of an oven, whereby the second layer having a dry coated amount of 3.0 g/m² was formed. In this manner, a hydrophilic member was obtained.

<First Layer Coating Solution (1)>

| | |
|---|---|
| 20 mass % aqueous solution of colloidal silica dispersion | 100 g |
| (Snowtex C, manufactured by NISSAN CHEMICAL | |
| INDUSTRIES, LTD.) | |
| Sol-gel prepared solution (1) described below | 500 g |
| 5 mass % aqueous solution of anionic surfactant | 30 g |
| (1) illustrated below | |
| Purified water | 450 g |

### <Sol-Gel Prepared Solution (1)>

The sol-gel prepared solution (1) was obtained by mixing 8 g of tetramethoxysilane (a product of TOKYO CHEMICAL INDUSTRY CO., LTD.) with 200 g of ethyl alcohol, 10 g of acetylacetone, 10 g of tetraethyl orthotitanate and 100 g of purified water, and stirring these ingredients for 2 hours at room temperature.

[Chem. 29]

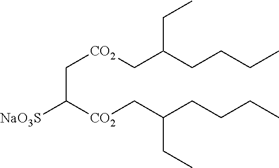

Anionic surfactant (1)

| <Hydrophilic Layer Coating solution (1)> | | |
|---|---|---|
| Sol-gel prepared solution (2) described below | 500 | g |
| ZPT | 7.5 | g |
| 5 mass % aqueous solution of anionic surfactant (1) illustrated above | 5.0 | g |

### <Sol-Gel Prepared Solution (2)>

The sol-gel prepared solution (2) was obtained by mixing 30 g of the following hydrophilic polymer <1> with 200 g of ethyl alcohol, 0.25 g of acetylacetone, 0.3 g of tetraethyl orthothitanate and 300 g of purified water, and stirring these ingredients for 2 hours at room temperature.

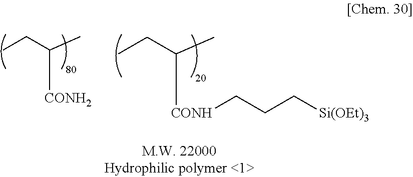

### (Evaluations)

The following evaluations were performed on the hydrophilic member. Evaluation results obtained are shown in Table 8.

Initial hydrophilicity: A water-drop contact angle was measured using distilled water in a contact-angle meter DropMaster 500 made by KYOWA INTERFACE SCIENCE CO., LTD.

Hydrophilicity persistence: A water-drop contact angle measurement was made on the hydrophilic member having undergone 10-day immersion in distilled water.

Scratch test: The hydrophilic member surface was swept with a 0.1-mm-dia sapphire stylus on which a load increased from 5 g in steps of 5 g was imposed, and the load giving a scratch (measured with a scratch-strength tester Type 186, made by SHINTO Scientific Co., Ltd.) was measured. A member surface suffering no scratch even when a heavier load is imparted thereon is said to be better in durability.

Water resistance: The hydrophilic member measuring 120 cm² in size was immersed in water and subjected to 10-time to-and-fro rubbing treatment with a sponge under a load of 10 kg, and the residual film rate was determined from a weight difference between before and after the treatment.

Antibacterial property: The antibacterial property evaluation was performed using the method conforming to JIS Z 2801 (antibacterial products—antibacterial property testing method/antibacterial effect).

### <Antibacterial Property Testing Method>

Antibacterial property testing can be performed in conformity with JIS Z 2801 (antibacterial products—antibacterial property testing method/antibacterial effect). As to bacteria, Escherichia coli and Staphylococcus aureus are prepared, and each of them is subjected to advance cultivation in a culture medium of common bouillon agar. One platinum loop of the advance culture thus made as a proof medium is dispersed into a culture medium of common bouillon diluted 500 times with distilled water, thereby preparing a proof bacterial solution wherein the number of bacteria is from 2.5×10⁵ to 10×10⁵ per ml. A test specimen (the hydrophilic member in the invention) cut to a width of 50 mm and a length of 50 mm is placed in a sterilized laboratory dish with the test side up, thereto 0.4 ml of the proof bacterial solution is added dropwise, the resulting test specimen is covered with a sterilized film of 40 mm square, the film is pressed lightly to distribute the proof bacterial solution over the whole film, the laboratory dish is covered with a lid, and then cultivation is carried out for 24 hours in a thermostatic-hydrostatic oven (35° C.±1° C., 90% Rh or higher). This testing is performed on three pieces for each test specimen. The SCDLP culture medium is added in amount of 10 ml to each laboratory dish after the cultivation, and thereby the proof bacteria are thoroughly washed away from each test piece and a film. Then the number of viable bacteria in each wash-out solution is measured according to the agar surface plate method, and the average value of such numbers is calculated. And an antibacterial activity value is determined from a difference between the number of viable bacteria before the testing and the number of viable bacteria after the testing. The antibacterial activity value can be calculated on the basis of the following expression.

Antibacterial activity value=Log(Y/X)

(In the expression, X represents an average value of numbers of viable bacteria in antibacterial test pieces, and Y represents an average value of numbers of viable bacteria in antibacterial agent-free unprocessed test pieces for comparison. Test specimens are accepted when rated A, while they are rejected when rated B.)

### (Criteria for Evaluation)

A: Antibacterial activity values greater than or equal to 2.0

B: Antibacterial activity values smaller than 2.0

Evaluation of antifungal property was made using the following method conforming to JIS Z 2911 (fungi resistance testing method).

### <Antifungal Property Testing Method>

Antifungal property testing can be performed in conformity with JIS Z 2911 (fungi resistance testing method). To begin with, a culture medium is prepared by dissolving Sabouraud's agar culture medium produced by NIHON PHARMACEUTICAL CO., LTD. in an amount of 650 g (containing 10.0 g of peptone, 40.0 g of glucose and 15.0 g of agar) in 1 litter of water. In addition, a mixed-spore suspension of 5 species of fungi spores (spores of Aspergillus niger, Penicillium, Rhizopus nigricans, Cladosporium Cladosporioides and Chaetomium) is prepared. And 25 ml of the culture medium is poured into a sterilized laboratory dish measuring 90 mm in diameter to form a plate agar. Then a sample (the hydrophilic member in the invention) measuring 30 mm in width and 30 mm in length is laid on the plate agar with the hydrophilic side up, 1 ml of the mixed-spore suspension is added dropwise to around the center of the sample's hydrophilic surface, and cultivation is carried out at 28° C.±2° C. The mixed-spore suspension added dropwise spreads over the whole surface of the hydrophilic surface and its surrounding culture medium. If the suspension does not spread over the surroundings, it is made to spread by use of a sterilized spreader. In order to avoid drying of the culture medium, the cultivation is performed in a thermostatic bath held at 28° C. approaching its saturation temperature. After a 72-hour lapse from the start of cultivation, the propagation frequency of fungi is visually observed, and thereby rated on a 1-to-4 scale (4 being best) according to growth area of fungi.

### (Criteria for Evaluation)

4: No growth of fungi is observed at all.

3: Partial growth of fungi is observed.

2: Growth of fungi is observed on about one-half the sample surface.

1: Growth of fungi is observed on almost all the sample surface.

### Comparative Examples 1 to 3

Hydrophilic members were made in the same manner as in Example 1, except that the amount of ZPT used was changed to those shown in Table 1, respectively, and thereon evaluations were performed as in Example 1.

TABLE 1

| | Amount of ZPT used | |
|---|---|---|
| Comparative Example 1 | 0.2 | g |
| Comparative Example 2 | 2 | g |
| Comparative Example 3 | 120 | g |

### Examples 2 to 5

Hydrophilic members were made in the same manner as in Example 1, except that ZPT was replaced with the antibacterial or antifungal agents shown in Table 2, respectively. Results obtained are shown in Table 9.

TABLE 2

| | Antibacterial agent or |
|---|---|
| | Antifungal agent |
| Example 2 | TBZ |
| Example 3 | BCM |
| Example 4 | OBPA |
| Example 5 | Silver zeolite |

### Example 6

A polyethylene terephthalate (PET) substrate (thickness: 50 μm) whose surface had been rendered hydrophilic by glow treatment was prepared, bar-coated with a first layer coating solution (2) having the following composition, and dried for 2 minutes in a 100° C. oven, whereby the first layer having a dry coated amount of 0.5 g/m² was formed. The water-drop contact angle of the first layer was found to be 80°. Subsequently thereto, a hydrophilic layer coating solution (2) for a second layer was bar-coated on the first layer, and dried for 10 minutes in a 100° C. oven, whereby the second layer having a dry coated amount of 1.0 g/m² was formed.

<First Layer Coating Solution (2)>

| Epikote 1009 (a product of Shell Chemicals Japan, Ltd.) | 100 | g |
|---|---|---|
| Takenate D110N (a product of Takeda Pharmaceutical Company Limited, solids content: | 100 | g |
| 10 mass %) | | |
| Methyl ethyl ketone | 1,200 | g |
| <Hydrophilic Layer Coating Solution (2)> | | |
| Sol-gel prepared solution (3) described below | 640 | g |
| ZPT | 70 | g |
| 20 mass % aqueous solution of colloidal silica dispersion (Snowtex C, a product of | 80 | g |
| NISSAN CHEMICAL INDUSTRIES, LTD.) | | |
| 5 mass % aqueous solution of anionic surfactant (2) illustrated below | 20 | g |

[Chem. 31] 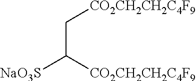
Anionic Surfactant (2)

### <Sol-Gel Prepared Solution (3)>

The sol-gel prepared solution (3) was obtained by mixing 50 g of tetramethoxysilane (a product of TOKYO CHEMICAL INDUSTRY CO., LTD.) and 20 g of the following hydrophilic polymer <2> into a mixture including 100 g of ethyl alcohol, 15 g of acetylacetone, 5 g of tetraethyl orthotitanate and 450 g of purified water, and stirring these ingredients for 2 hours at room temperature.

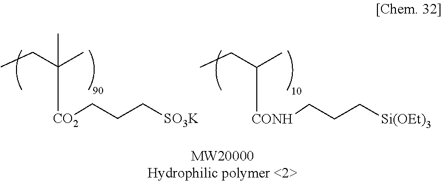

### Examples 7 to 10

Hydrophilic members were made in the same manner as in Example 6, except that ZPT was replaced with the antibacterial or antifungal agents shown in Table 3, respectively. Results obtained are shown in Table 9.

TABLE 3

| | Antibacterial Agent or |
|---|---|
| | Antifungal Agent |
| Example 7 | TCMTB |
| Example 8 | BIT |
| Example 9 | Cresol |
| Example 10 | Silver behenate |

### Example 11

An alkali-degreased aluminum substrate (thickness: 0.15 mm) was prepared, and bar-coated with a first layer coating solution (3) having the following composition, and then dried at 100° C. for 10 minutes by means of an oven, whereby the first layer having a dry coated amount of 0.1 g/m² was formed. After sufficient cooling at room temperature, the first layer-coated surface was bar-coated with the hydrophilic layer coating solution (1) used in Example 1 for forming the second layer, and dried at 150° C. for 30 minutes by means of an oven, whereby the second layer having a dry coated amount of 0.5 g/m² was formed. In this manner, a hydrophilic member was made, and thereon evaluations were performed as in Example 1.

<First Layer Coating Solution (3)>

| | |
|---|---|
| Sol-gel prepared solution (4) described below | 500 g |
| 5 mass % aqueous solution of anionic surfactant | 30 g |
| (1) illustrated above | |
| Purified water | 450 g |

### <Sol-Gel Prepared Solution (4)>

The sol-gel prepared solution (4) was obtained by mixing 4 g of tetramethoxysilane (a product of TOKYO CHEMICAL INDUSTRY CO., LTD.) and 4 g of methyltrimethoxysilane (a product of TOKYO CHEMICAL INDUSTRY CO., LTD.) into a mixture including 200 g of ethyl alcohol, 10 g of acetylacetone, 10 g of tetraethyl orthotitanate and 100 g of purified water, and stirring these ingredients for 2 hours at room temperature.

### Comparative Example 4

A hydrophilic member was made in the same manner as in Example 11, except that the hydrophilic polymer (1) in the hydrophilic layer coating solution (1) was replaced with polyacrylamide (MW: 20,000), and thereon evaluations were performed.

### Examples 12 to 15

Hydrophilic members were made in the same manner as in Example 6, except that ZPT was replaced with the antibacterial or antifungal agents shown in Table 4, respectively. Results obtained are shown in Table 9.

TABLE 4

| | Antibacterial Agent or |
|---|---|
| | Antifungal Agent |
| Example 12 | TBZ |
| Example 13 | BCM |
| Example 14 | OBPA |
| Example 15 | Silver behenate |

### Example 16

A hydrophilic member was made in the same manner as in Example 15, except that the hydrophilic layer coating solution (1) was replaced with the hydrophilic layer coating solution (3), and thereon evaluations were performed.

<Hydrophilic Layer Coating Solution (3)>

| | |
|---|---|
| Sol-gel prepared solution (5) described below | 500 g |
| ZPT | 7.5 g |
| 5 mass % aqueous solution of anionic surfactant | 5.0 g |
| (1) illustrated above | |

### <Sol-Gel Prepared Solution (5)>

The sol-gel prepared solution (5) was obtained by mixing 23 g of the hydrophilic polymer <1> and 20 g of the following hydrophilic polymer <3> into a mixture including 200 g of ethyl alcohol, 0.25 g of acetylacetone, 0.3 g of tetraethyl orthotitanate and 300 g of purified water, and stirring these ingredients for 2 hours at room temperature.

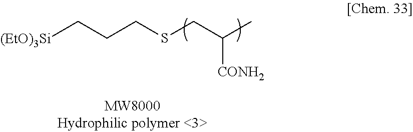

### Examples 17 to 20

Hydrophilic members were made in the same manner as in Example 16, except that the anionic surfactant (1) was replaced with the anionic surfactant (2) and the ZPT content of the hydrophilic layer coating solution (3) was changed to those shown in Table 5, respectively, and thereon evaluations were performed.

TABLE 5

| | Sol-Gel Prepared | | Anionic |
|---|---|---|---|
| | Solution (5) | ZPT | Surfactant (2) |
| Example 17 | 500 g | 4.0 g | 5.0 g |
| Example 18 | 500 g | 7.5 g | 5.0 g |
| Example 19 | 500 g | 19.0 g | 5.0 g |
| Example 20 | 500 g | 43.5 g | 5.0 g |

### Examples 21 to 25

Hydrophilic members were prepared in the same manner as in Example 19, except that the hydrophilic polymer <1> was replaced with a hydrophilic polymer <4>, the hydrophilic polymer <3> was replaced with a hydrophilic polymer <5> and ZPT was replaced with the antibacterial or antifungal agents shown in Table 6, respectively, and thereon evaluations were performed.

TABLE 6

| | Antibacterial Agent or |
|---|---|
| | Antifungal Agent |
| Example 21 | ZPT |
| Example 22 | TBZ |
| Example 23 | BCM |
| Example 24 | OBPA |
| Example 25 | Silver behenate |

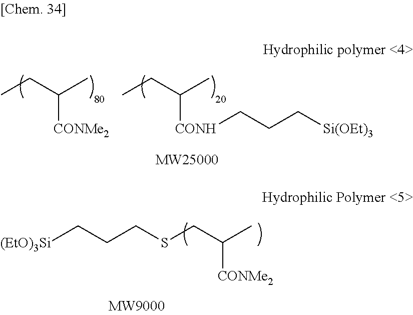

### Examples 26 to 30

An SUS substrate (made of stainless steel and 1.1 mm in thickness) whose surface had been rendered hydrophilic by 10-minute UV/O₃ treatment was bar-coated with the first layer coating solution (2) having the composition described above, and dried at 100° C. for 2 minutes by means of an oven, whereby a layer having a dry coated amount of 0.5 g/m² was formed. The water-drop contact angle of a first layer thus formed was found to be 80°. Further, the first layer was bar-coated with a first layer coating solution (4) having a composition mentioned below, and then dried at 100° C. for 10 minutes by means of an oven, whereby a layer having a dry coated amount of 0.5 g/m² was formed. Thus the first layer of two-layer structure was formed. The water-drop contact angle of the layer formed with the firs layer coating solution (4) was found to be 10°. And subsequently the first layer of two-layer structure was bar-coated with the following hydrophilic layer coating solution (4) for a second layer, and dried at 150° C. for 30 minutes by means of an oven, whereby the second layer having a dry coated amount of 0.5 g/m² was formed. In this way, hydrophilic members were obtained.

<Hydrophilic Layer Coating Solution (4)>

| | |
|---|---|
| Sol-gel prepared solution (6) described below | 500 g |
| Antibacterial or antifungal agent shown in Table 7 | 7.5 g |
| 5 mass % aqueous solution of the anionic surfactant | 5.0 g |
| (1) illustrated above | |

TABLE 7

| | Antibacterial Agent or |
|---|---|
| | Antifungal Agent |
| Example 26 | ZPT |
| Example 27 | TCMTB |
| Example 28 | BIT |
| Example 29 | Cresol |
| Example 30 | Silver zeolite |

### <Sol-Gel Prepared Solution (6)>

The sol-gel prepared solution (6) was obtained by mixing 23 g of a hydrophilic polymer <6> illustrated below and 7 g of a hydrophilic polymer <7> illustrated below into a mixture including 200 g of ethyl alcohol, 0.25 g of acetylacetone, 0.3 g of tetraethyl orthotitanate and 300 g of purified water, and then stirring these ingredients for 2 hours at room temperature.

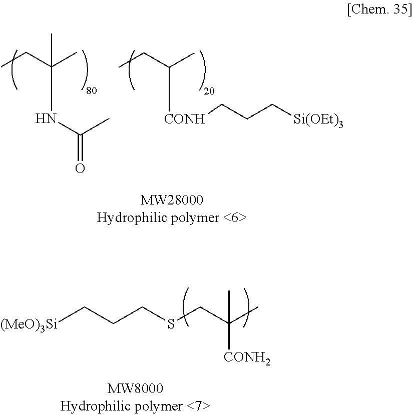

### Examples 31 to 33

Hydrophilic members were made in the same manner as in Example 26, except that the content of the hydrophilic layer coating solution (4) was changed to those shown in Table 8, respectively, and thereon evaluations were performed.

TABLE 8

| | Sol-Gel Prepared | | Anionic |
|---|---|---|---|
| | Solution (6) | ZPT | Surfactant (1) |
| Example 31 | 500 g | 5.1 g | 5.0 g |
| Example 32 | 500 g | 19.0 g | 5.0 g |
| Example 33 | 500 g | 67.8 g | 5.0 g |

TABLE 9

| | Content of | | | | | | |
|---|---|---|---|---|---|---|---|
| | Antibacterial or | Initial | Hydrophilicity | Scratch | Water | Antibacterial | Antifungal |
| | Antifungal Agent | Hydrophilicity | Persistence | Test | Resistance | Property | Property |
| Example 1 | 20 mass % | 8° | 9° | 80 g | 99% | A | 4 |
| Example 2 | 20 mass % | 9° | 10° | 70 g | 97% | A | 4 |
| Example 3 | 20 mass % | 9° | 11° | 70 g | 97% | A | 4 |
| Example 4 | 20 mass % | 9° | 10° | 75 g | 98% | A | 4 |
| Example 5 | 20 mass % | 8° | 9° | 80 g | 99% | A | 4 |
| Example 6 | 40 mass % | 8° | 9° | 85 g | 100% | A | 4 |
| Example 7 | 40 mass % | 10° | 11° | 75 g | 98% | A | 4 |
| Example 8 | 40 mass % | 10° | 11° | 75 g | 98% | A | 4 |
| Example 9 | 40 mass % | 9° | 11° | 80 g | 99% | A | 4 |
| Example 10 | 40 mass % | 8° | 9° | 85 g | 100% | A | 4 |
| Example 11 | 20 mass % | 8° | 9° | 80 g | 99% | A | 4 |
| Example 12 | 40 mass % | 9° | 10° | 70 g | 97% | A | 4 |
| Example 13 | 40 mass % | 9° | 11° | 70 g | 97% | A | 4 |
| Example 14 | 40 mass % | 9° | 11° | 75 g | 98% | A | 4 |
| Example 15 | 40 mass % | 8° | 9° | 80 g | 99% | A | 4 |
| Example 16 | 20 mass % | 6° | 7° | 80 g | 99% | A | 4 |
| Example 17 | 13 mass % | 7° | 9° | 80 g | 99% | A | 4 |
| Example 18 | 20 mass % | 6° | 7° | 80 g | 99% | A | 4 |
| Example 19 | 40 mass % | 5° | 5° | 90 g | 100% | A | 4 |
| Example 20 | 60 mass % | 5° | 5° | 90 g | 100% | A | 4 |
| Example 21 | 40 mass % | 5° | 5° | 90 g | 100% | A | 4 |
| Example 22 | 40 mass % | 11° | 13° | 65 g | 96% | A | 4 |
| Example 23 | 40 mass % | 11° | 13° | 65 g | 96% | A | 4 |
| Example 24 | 40 mass % | 12° | 14° | 70 g | 97% | A | 4 |
| Example 25 | 40 mass % | 7° | 9° | 80 g | 99% | A | 4 |
| Example 26 | 20 mass % | 6° | 7° | 80 g | 99% | A | 4 |
| Example 27 | 20 mass % | 9° | 11° | 70 g | 97% | A | 4 |
| Example 28 | 20 mass % | 9° | 11° | 70 g | 97% | A | 4 |
| Example 29 | 20 mass % | 9° | 12° | 75 g | 98% | A | 4 |
| Example 30 | 20 mass % | 7° | 8° | 80 g | 99% | A | 4 |
| Example 31 | 15 mass % | 7° | 8° | 80 g | 99% | A | 4 |
| Example 32 | 40 mass % | 7° | 7° | 90 g | 100% | A | 4 |
| Example 33 | 70 mass % | 8° | 8° | 90 g | 100% | A | 4 |
| Comparative | 0.7 mass % | 8° | 9° | 80 g | 99% | B | 2 |
| Example 1 | | | | | | | |
| Comparative | 6 mass % | 8° | 9° | 80 g | 99% | A | 3 |
| Example 2 | | | | | | | |
| Comparative | 80 mass % | 9° | 25° | 50 g | 70% | A | 4 |
| Example 3 | | | | | | | |
| Comparative | 20 mass % | 15° | 30° | 45 g | 60% | A | 4 |
| Example 4 | | | | | | | |

The antifungal agents used are as follows.

ZPT: Bis(2-pyridylthio-1-oxide)zinc

TBZ: 2-(4-Thiazolyl)benzimidazole

BCM: Methyl 2-benzimidazole carbamate

OBPA: 10,10′-Oxybisphenoxyarsine

TCMTB: 2-(4-Thiocyanomethyl)benzimidazole

BIT: 1,2-Benzothiazolone

Cresol: Methylphenol

As can be seen from Table 9, the hydrophilic members using the present hydrophilic compositions excel in high-temperature keeping quality, antifungal property and water resistance.

### INDUSTRIAL APPLICABILITY

The invention can provide a hydrophilic composition which has high hydrophilic property and hydrophilicity persistence and forms a hydrophilic layer exhibiting excellent antibacterial and antifungal effects, and further provide a hydrophilic member.

Although the invention has been illustrated in detail and by reference to specific embodiments, it is apparent to those skilled in the art that various changes and modifications can be made without departing from the spirit and scope of the invention.

This application is based on a Japanese patent application filed on Oct. 17, 2008 (Japanese Patent Application No. 2008-268777), and the contents thereof are incorporated herein by reference.

1. A hydrophilic composition which comprises a hydrophilic polymer (I) containing a structure represented by the following general formula (I-1) and a structure represented by the following general formula (I-2), and an additive having antibacterial or antifungal property in an amount exceeding 10 mass % with respect to the total solids content of the hydrophilic composition: 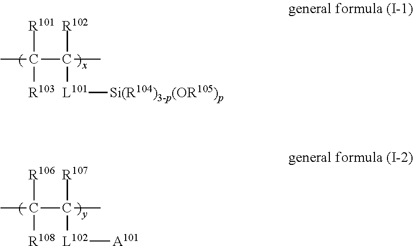
wherein, in the general formulae (I-1) and (I-2), R¹⁰¹ to R¹⁰⁸ each independently represents a hydrogen atom or a hydrocarbon group, p represents an integer of from 1 to 3, L¹⁰¹ and L¹⁰² each independently represents a single bond or a polyvalent organic linking group, x and y each represents a composition ratio, with x being 0<x<100 and y being 0<y<100, A¹⁰¹ represents —OH, —ORₐ, —CORₐ, —CO₂R_{c}, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), in which Rₐ, R_{b}, and R_{c} each independently represents a hydrogen atom or a straight, branched or cyclic alkyl group, R_{d} represents a straight, branched or cyclic alkyl group, Rₑ and R_{f} each independently represents a hydrogen atom, a straight, branched or cyclic alkyl group, an alkali metal, an alkaline earth metal or an onium, and R_{g} represents a halogen ion, an inorganic anion or an organic anion.

2. The hydrophilic composition as claimed in claim 1, which further comprises a hydrophilic polymer (II) which includes a structure represented by the following general formula (II-1) and a structure represented by the following general formula (II-2): 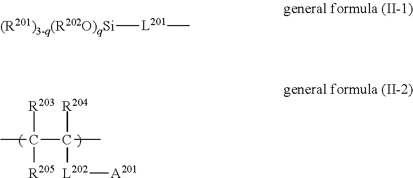
wherein, in the general formulae (II-1) and (II-2), R²⁰¹ to R²⁰⁵ each independently represents a hydrogen atom or a hydrocarbon group, q represents an integer of 1 to 3, L²⁰¹ to L²⁰² each independently represents a single bond or a polyvalent organic linking group, A²⁰¹ represents —OH, —ORₐ, —CORₐ, —CO₂Rₑ, —CON(Rₐ)(R_{b}), —N(Rₐ)(R_{b}), —NHCOR_{d}, —NHCO₂Rₐ, —OCON(Rₐ)(R_{b}), —NHCON(Rₐ)(R_{b}), —SO₃Rₑ, —OSO₃Rₑ, —SO₂R_{d}, —NHSO₂R_{d}, —SO₂N(Rₐ)(R_{b}), —N(Rₐ)(R_{b})(R_{c}), —N(Rₐ)(R_{b})(R_{c})(R_{g}), —PO₃(Rₑ)(R_{f}), —OPO₃(Rₑ)(R_{f}) or —PO₃(R_{d})(Rₑ), in which Rₐ, R_{b} and R_{c} each independently represents a hydrogen atom or a straight, branched or cyclic alkyl group, R_{d} represents a straight, branched or cyclic alkyl group, Rₑ and R_{f} each independently represents a hydrogen atom, a straight, branched or cyclic alkyl group, an alkali metal, an alkaline earth metal or an onium, and R_{g} represents a halogen ion, an inorganic anion or an organic anion.

3. The hydrophilic composition as claimed in claim 1 or 2, wherein the additive having antibacterial or antifungal property is contained in an amount of 15 to 70 mass % with respect to the total solids content of the hydrophilic composition.

4. The hydrophilic composition as claimed in claim 2 or 3, wherein a mass ratio of the hydrophilic polymer (I) to the hydrophilic polymer (II), being contained in the hydrophilic composition, (hydrophilic polymer (I)/hydrophilic polymer (II)) is in a range of from 50/50 to 95/5.

5. The hydrophilic composition as claimed in any one of claims 1 to 4, wherein the additive having antibacterial or antifungal property contains at least one member selected from a water-soluble or water-dispersible organic compound and a silver based inorganic compound.

6. The hydrophilic composition as claimed in any one of claims 1 to 5, wherein the additive having antibacterial or antifungal property contains at least one member selected from an imidazole based compound, an arsine based compound, a pyridine based compound and a silver based compound.

7. The hydrophilic composition as claimed in any one of claims 1 to 6, wherein the additive having antibacterial or antifungal property contains at least one member selected from 2-(4-thiazolyl)benzimidazole, methyl 2-benzimidazole carbamate, 10,10′-oxybisphenoxyarsine, bis(2-pyridylthio-1-oxide)zinc, silicate based silver zeolite and silver behenate.

8. A hydrophilic member which contains a hydrophilic layer formed with the hydrophilic composition as claimed in any one of claims 1 to 7 on a substrate selected from acrylic resin, polycarbonate based resin, polyester based resin, stainless steel and aluminum.

9. A fin stock which contains a fin body and a hydrophilic layer provided on at least part of the surface of the fin body, wherein the hydrophilic layer is formed by coating with the hydrophilic composition as claimed in any one of claims 1 to 7.

10. The fin stock as claimed in claim 9, wherein the fin body is made from aluminum.

11. A heat exchanger which utilizes the fin stock as claimed in claim 10.

12. An air conditioner which utilizes the heat exchanger as claimed in claim 11.
